(19) United States
(12) Patent Application Publication
(10) Pub. No.: US 2026/0296965 A1
(43) Pub. Date: Oct. 1, 2026

(54) FIRE-RESISTANT GYPSUM BOARDS AND SUSTAINABLE METHODS FOR PRODUCTION THEREOF

(71) Applicant: United States Gypsum Company, Chicago, IL (US)

(72) Inventors: Ali POURNAGHSHBAND ISFAHANI, Gurnee, IL (US); Qinghua Li, Rolling Meadows, IL (US); Annamaria Vilinska, Chicago, IL (US)

(73) Assignee: United States Gypsum Company, Chicago, IL (US)

(21) Appl. No.: 19/362,071

(22) Filed: Oct. 17, 2025

Related U.S. Application Data
(60) Provisional application No. 63/779,044, filed on Mar. 27, 2025.

(51) Int. Cl. C04B 11/30; B28B 1/30; B28B 11/12; C04B 111/00

(52) U.S. Cl. CPC C04B 11/30; B28B 1/30; B28B 11/12; C04B 2111/00482; C04B 2111/0062; C04B 2201/30

(57) ABSTRACT

Disclosed are gypsum boards and methods of preparing gypsum board. The board contains a set gypsum core disposed between two cover sheets. If desired, a dense skim coat layer can be applied between the core and one or both cover sheets. Colloidal silica and, optionally, fumed silica is used to form the board core. A core slurry contains water, stucco, foaming agent, colloidal silica, and optionally silica fume, and other optional ingredients. If present, first and second skim coat layers can be prepared from dense slurry. Surprisingly and unexpectedly, the resulting gypsum board exhibits enhanced fire-resistance properties, such as with respect to thermal shrinkage and/or insulation, while also allowing for lower water-to-stucco ratios during manufacture. As such, the gypsum board can be sustainably produced, requiring lower energy to remove excess water, and allowing for production efficiencies.

### CROSS-REFERENCE TO RELATED APPLICATIONS

This patent application claims the benefit of U.S. Provisional Patent Application No. 63/779,044, filed Mar. 27, 2025, which is incorporated by reference herein in its entirety.

### BACKGROUND OF THE INVENTION

Set gypsum is a well-known material that is used in many products, including panels and other products for building construction and remodeling. One such panel (often referred to as gypsum board) is in the form of a set gypsum layer sandwiched between two cover sheets (e.g., paper-faced board) and is commonly used in drywall construction of interior walls and ceilings of buildings. One or more dense layers, often referred to as “skim coats” can be included on either side of the core, usually at the paper-core interface.

Gypsum (calcium sulfate dihydrate) is naturally occurring and can be mined in rock form. It can also be in synthetic form (referred to as “syngyp” in the art) as a by-product of industrial processes such as flue gas desulfurization. From either source (natural or synthetic), gypsum can be calcined at high temperature to form stucco (i.e., calcined gypsum primarily in the form of calcium sulfate hemihydrate) and then rehydrated to form set gypsum in a desired shape (e.g., as a board).

During manufacture of the board, stucco (i.e., calcined gypsum in the form of calcium sulfate hemihydrate and/or calcium sulfate anhydrite), water, and other ingredients as appropriate are mixed in a mixer (e.g., a pin mixer known in the art). A slurry is formed and discharged from the mixer onto a moving conveyor carrying a cover sheet with one of the skim coats (if present) already applied (often upstream of the mixer). The slurry is spread over the paper (with skim coat optionally included on the paper). Another cover sheet, with or without skim coat, is applied onto the slurry to form the sandwich structure of desired thickness with the aid of, e.g., a forming plate or the like. The mixture is cast and allowed to harden to form set (i.e., rehydrated) gypsum by reaction of the calcined gypsum with water to form a matrix of crystalline hydrated gypsum (i.e., calcium sulfate dihydrate). It is the desired hydration of the calcined gypsum that enables the formation of the interlocking matrix of set gypsum crystals, thereby imparting strength to the gypsum structure in the product. Heat is required (e.g., in a kiln) to drive off the remaining free (i.e., unreacted) water to yield a dry product.

One benefit of using gypsum in wallboard is that gypsum has a natural fire resistance property. Should the finished gypsum board be exposed to relatively high temperatures, such as those produced by high temperature flames or gases, portions of the set gypsum layer may absorb sufficient heat to start the release of water from the gypsum dihydrate crystals of the core. The absorption of heat and release of water from the gypsum dihydrate may be sufficient to retard heat transmission through or within the panels for a time. Gypsum board may experience shrinkage of the panel dimensions in one or more directions as one result of some or all of these high temperature heating effects, and such shrinkage may cause failures in the structural integrity of the board.

Some gypsum board products are designed to have enhanced fire resistance as compared with the property of the set gypsum alone. One example of an additive that enhances the fire resistance of gypsum board is high expansion vermiculite, which can be included in the gypsum slurry for forming the gypsum board, as described in, e.g., U.S. Pat. No. 8,323,785. One drawback is that such vermiculite can be in short supply. Such vermiculite is one of the most important additives in the formulation of fire-resistant gypsum wallboard, such as ULX and ULIX (ultralight board). Typical commercial products are USG SHEETROCK® brand Firecode C and Firecode EcoSmart Type X panels.

Some fire-resistant board is considered “fire-rated” when the board passes certain tests while in an assembly of wallboards affixed to studs. The fire-ratings relate to the assembly passing certain tests, including certain tests of Underwriters Laboratories (UL), including UL tests U305, U419, and U423 (sometimes simply called UL 305, UL 419, and UL 423).

It will be appreciated that this background description has been created by the inventors to aid the reader, and is not to be taken as a reference to prior art nor as an indication that any of the indicated problems were themselves appreciated in the art. While the described principles can, in some regards and embodiments, alleviate the problems inherent in other systems, it will be appreciated that the scope of the protected innovation is defined by the attached claims, and not by the ability of any embodiments of the disclosure to solve any specific problem noted herein.

### BRIEF SUMMARY OF THE INVENTION

The disclosure pertains to gypsum board and a method of preparing gypsum board using colloidal silica, and optionally fumed silica. The gypsum board can be in the form of wallboard. As used herein, the term “wallboard” is not limited to the use of the board on walls, but can also include boards used for ceilings, partitions, etc. The board includes a set gypsum core disposed between first and second cover sheets (commonly face and back sheets, respectively). The set gypsum core is formed from a gypsum slurry comprising stucco, water, colloidal silica, optionally the silica fume, and other optional ingredients as desired, including, for example, foaming agent, accelerator (e.g., heat resistant accelerator), dispersant (e.g., polynaphthalene sulfonate), retarder, strength-enhancing starch, migrating starch, and polyphosphate. The face side of the board normally is facing out and is visible when hanging in use, while the back side faces inward, toward support structures such as studs. If desired, a dense skim coat layer (sometimes referred to as a dense layer or skim coat layer) can be applied between the core and one or both cover sheets.

The set gypsum core is formed from a slurry that contains the colloidal silica and optionally the fumed silica, whereas in the dense skim coat layers, if present, fumed silica and/or colloidal silica is optional. The dense skim coat layers can be the same or different from the core. The core is typically formed from a single slurry. The dense layers are formed from slurries that can have the same or different composition from the core, e.g., because of similarity or variation with the presence of the colloidal silica and fumed silica. The dense layer slurries comprise water, stucco, silica fume, and an optional colloidal silica in some embodiments.

In some embodiments, the colloidal silica is in the form of a liquid suspension of amorphous particles carrying a negative or neutral surface charge. In some embodiments, the colloidal silica has an average particle diameter of from 1 nm to 100 nm (e.g., from 5 to 60 nm, or from 10 to 30 nm, such as 20 nm); a specific gravity of from 1 g/cm³ to 1.5 g/cm³ (such as from 1.1 g/cm³ to 1.4 g/cm³, or from 1.1 g/cm³ to 1.3 g/cm³); and optionally a specific surface area measured in accordance with the BET method of from 20 to 1500 m²/kg. Surprisingly and unexpectedly, the resulting board provides enhanced fire resistance properties while also allowing for the use of a core slurry with low water-to-stucco ratios. Furthermore, in some embodiments, an organic dispersant can be excluded inasmuch as the addition of colloidal silica into the core slurry surprisingly increases fluidity without negative impact on the setting time.

Exclusion of expandable vermiculite is further beneficial since it tends to be scarce and in short supply. Vermiculite may also raise toxicity concerns as it may contain asbestos in its compositions, which has detrimental health effects. Thus, in some embodiments, the boards and methods exclude asbestos, e.g., including asbestos-containing additives. In some embodiments, the board is fire-rated when tested in an assembly as discussed herein.

In one aspect, the present invention provides a gypsum board comprising a set gypsum core disposed between two cover sheets. The set gypsum core is formed from a core slurry comprising water, stucco, colloidal silica, and optionally silica fume. In embodiments, the gypsum board exhibits at least one (i.e., one, two, three, four, or five) of the following items (1)-(5). (1) A High Temperature Shrinkage (S) of 10% or less in the z direction when heated to 1560° F. (850° C.), according to ASTM C1795-15. (2) A High Temperature Shrinkage (S) of 10% or less in the x-y directions (width-length) when heated to 1560° F. (850° C.) according to ASTM C1795-15. (3) A Thermal Insulation Index (TI) of 20 minutes or greater according to ASTM C1795-15. (4) A High Temperature Thickness Expansion in the z direction of at least 0.1% when thickness is evaluated according to the analogous techniques and methodology of ASTM C1795-15. (5) When the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than 325° F. plus ambient temperature after at least 60 minutes; or an average value of the temperature sensors is less than 250° F. plus ambient temperature after at least 60 minutes.

In another aspect, the present invention provides a method of making a gypsum board. The method comprises mixing stucco, water, colloidal silica, and optionally silica fume to form a core slurry. The core slurry is placed between two cover sheets to form a board precursor. The slurry in the board precursor is allowed to set to form the board. The board is cut. In embodiments, the gypsum board exhibits at least one of the following items (1)-(5). (1) A High Temperature Shrinkage (S) of 10% or less in the z direction when heated to 1560° F. (850° C.), according to ASTM C1795-15. (2) A High Temperature Shrinkage (S) of 10% or less in the x-y directions (width-length) when heated to 1560° F. (850° C.) according to ASTM C1795-15. (3) A Thermal Insulation Index (TI) of 20 minutes or greater according to ASTM C1795-15. (4) A High Temperature Thickness Expansion in the z direction of at least 0.1% when thickness is evaluated according to the analogous techniques and methodology of ASTM C1795-15. (5) When the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than 325° F. plus ambient temperature after at least 60 minutes; or an average value of the temperature sensors is less than 250° F. plus ambient temperature after at least 60 minutes.

In another aspect, invention provides a gypsum board comprising face and back cover sheets with a board core disposed between the cover sheets. The core comprises set gypsum formed from a core slurry comprising water, stucco, and colloidal silica and an optional silica fume. A back skim coat layer defining first and second back skim coat faces is formed from a back skim coat slurry comprising water, stucco, silica fume and an optional colloidal silica. The back skim coat is disposed in bonding relation to the core with the first face of the back skim coat layer facing the back cover sheet and the second face of the back skim coat layer facing the board core. A face skim coat layer defining first and second face skim coat faces is formed from a face skim coat slurry comprising water, stucco, silica fume and an optional colloidal silica. The face skim coat layer is disposed in bonding relation to the core with the first face of the face skim coat layer facing the face cover sheet and the second face of the face skim coat layer facing the board core. The back skim coat slurry and the face skim coat slurry can be the same or different. In the core slurry, silica fume is present in an amount of from 0% to 8% by weight of the stucco, such as from 1% to 7% by weight of the stucco, or from 2% to 6% by weight of the stucco, or from 3% to 5% by weight of the stucco. In the back skim coat layer or the face skim coat layer, silica fume is present in an amount of from 2% to 12% by weight of the stucco, such as from 3% to 10% by weight of the stucco, or from 4% to 8% by weight of the stucco, or from 5% to 7% by weight of the stucco. The silica fume present in the back skim coat slurry and the face skim coat slurry can be the same or different. In embodiments, the gypsum board exhibits at least one of the following items (1)-(5). (1) A High Temperature Shrinkage (S) of 10% or less in the z direction when heated to 1560° F. (850° C.), according to ASTM C1795-15. (2) A High Temperature Shrinkage (S) of 10% or less in the x-y directions (width-length) when heated to 1560° F. (850° C.) according to ASTM C1795-15. (3) A Thermal Insulation Index (TI) of 20 minutes or greater according to ASTM C1795-15. (4) A High Temperature Thickness Expansion in the z direction of at least 0.1% when thickness is evaluated according to the analogous techniques and methodology of ASTM C1795-15. (5) When the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than 325° F. plus ambient temperature after at least 60 minutes; or an average value of the temperature sensors is less than 250° F. plus ambient temperature after at least 60 minutes.

Further and alternative aspects and features of the disclosed principles will be appreciated from the following detailed description and the accompanying drawings. As will be appreciated, the slurries, boards, and methods disclosed herein are capable of being carried out and used in other and different embodiments, and capable of being modified in various respects. Accordingly, it is to be understood that both the foregoing general description and the following detailed description are exemplary and explanatory only and do not restrict the scope of the appended claims.

### DETAILED DESCRIPTION OF THE INVENTION

One benefit of using gypsum in wallboard is gypsum's naturally occurring fire resistance properties. As discussed herein, thermal properties (e.g., fire resistance) are a measure of the ability of a gypsum board to delay flames and heat from spreading in the event of a fire. Typically, delaying the rate at which flames and heat can spread in the circumstance of a fire allows for structural supports to be protected, as well as occupants and rescue teams to escape.

Gypsum molecules contain one molecule of calcium sulfate combined with two molecules of water. The presence of water in gypsum molecules, among other things, contributes greatly to a given gypsum wallboard's natural fire resistance. In the event that a finished gypsum board is subjected to high levels of heat (e.g., such as those produced by high temperature flames or gases), portions of the set gypsum layer can absorb sufficient heat to start the release of water in the form of steam from the gypsum dihydrate crystals of the core. This process is known as calcination. Such processes help to retard heat transmission through the board (sometimes referred to herein as a panel) for a time.

A gypsum board may continue to act as a fire barrier should all the water escape the panel; however, conventional board may shrink due to the loss of water in the face of high heat. Shrinkage may result in cracks, which compromise and ultimately contribute to the falling apart of the board. Failure in the integrity of the board permits the passage of fire and heat into not only the constituent substrate materials of the remaining board and structure, but into rooms or areas beyond the board itself. As such, a need exists in the art to counter the shrinkage and extend the longevity of gypsum board in high temperature conditions. Fire resistant boards can be evaluated on their ability to delay heat and/or flame in accordance with the tests described herein. In accordance with some embodiments, some fire-resistant board is further considered “fire-rated” when the board passes certain tests while in an assembly, as discussed herein.

Embodiments of the disclosure provide a fire-resistant gypsum board, as well as related slurries and methods. The gypsum board contains a set gypsum core disposed between face and back cover sheets. The set gypsum core forms the largest bulk (majority) of the gypsum in the board. If desired, much thinner skim coats can be disposed between the core and one or both of the cover sheets. The skim coats generally have higher densities than the core slurry. The skim coat between the core and the face cover sheet is sometimes referred to herein as the face skim coat, while the skim coat between the core and the back cover sheet is sometimes referred to herein as the back skim coat. The set gypsum core is formed from a core slurry, while a face dense slurry and a back dense slurry form the face and back skim coats, respectively.

The disclosure is premised, at least in part, on using colloidal silica, and optionally silica fume in the slurry for forming the set gypsum core. Preferably, however, the face and back skim coat slurries (which preferably have the same composition) do not contain the colloidal silica and fumed silica. Surprisingly and unexpectedly, the gypsum board can achieve better fire-resistance properties than relying only on gypsum's natural heat sink ability, while also allowing for the use of low water-to-stucco ratios (WSR). The set gypsum core is formed from a core slurry containing water, stucco, and other ingredients as desired, e.g., foaming agent, dispersant, retarder, accelerator, migrating starch, strength enhancing starch, sodium trimetaphosphate (STMP), etc. To enhance fire resistance while allowing for the use of low WSR, colloidal silica and, optionally, silica fume, is included in the core slurry.

In accordance with some embodiments, some fire-resistant board is considered “fire-rated” when the board passes certain tests while in an assembly, as discussed herein. Surprisingly and unexpectedly, the inventors have discovered that the inclusion of the colloidal silica, e.g., in combination with silica fume, provides a significant benefit in fire resistant board as it prevents the board from shrinking considerably upon heating. Such properties are beneficial because the colloidal silica and silica fume can compensate for the shrinkage of the board when exposed to heat, e.g., fire. As discussed herein, shrinkage of the gypsum is undesirable since cracks will form in the board, thereby allowing fire to undesirably travel through the board. At the same time, these ingredients do not increase water demand and therefore allow for lower WSR's to be employed. The colloidal silica can be added in an aqueous dispersion containing particles (e.g., amorphous) that contain a negative or neutral surface charge. Preferably, the colloidal silica is not an acidic dispersion and does not contain a positive surface charge. In some embodiments, the colloidal silica bears a negative surface charge. To achieve the desired charge, the colloidal silica can contain one or more steric groups as known in the art as a substituent that influences the shape, reactivity, and interactions of a molecule due to its size and spatial arrangement, to affect charge distribution and stability, e.g., by hindering or enabling certain types of interactions that stabilize or destabilize charges.

The inventors have found that, surprisingly and unexpectedly, certain other shrinkage and thermal additives or compositions are not necessary and can be excluded in the core or dense layers as described herein. As such, in some embodiments, the preparation of any of the layers of the gypsum board can avoid the use of ingredients such as one or more of perlite, lime, expandable graphite, silicones, ceramic oxides, metal salts, vermiculite, metal hydroxides, volcanic rock, amorphous volcanic glass, synthetic porous materials, and/or mineral hydrites. In embodiments, a single slurry is used to form the core (majority) of the board thickness. This core slurry includes water, stucco, foaming agent, the colloidal silica and optional fumed silica. In contrast, one or two other slurries are used to form the dense layer(s) with the use of the same or different formulation from the core. The dense layer comprises water, stucco, silica fume, and an optional colloidal silica in some embodiments. This approach greatly simplifies the manufacturing process, allowing for lower water demand, greater efficiency, less energy consumption, and more sustainability such that the resulting gypsum boards are considered to be using green technology.

Surprisingly and unexpectedly, the low water-to-stucco ratio can be any suitable ratio, which allows for efficiencies because less excess water will remain after the hydration process of the stucco is completed during manufacture, thereby conserving energy. For example, the core slurry formulations can be made with a water/stucco ratio of 1.1 or less, such as from 0.3 to 1.1; 0.3 to 1; 0.3 to 0.9; 0.3 to 0.85; 0.3 to 0.8; 0.3 to 0.75; 0.3 to 0.7; 0.3 to 0.6; 0.3 to 0.5; 0.4 to 1.1; 0.4 to 1; 0.4 to 0.9; 0.4 to 0.85; 0.4 to 0.75; 0.4 to 0.7; 0.4 to 0.6; 0.4 to 0.5; 0.5 to 1.1; 0.5 to 1; 0.5 to 0.9; 0.5 to 0.85; 0.5 to 0.8; 0.5 to 0.75; 0.5 to 0.7; 0.5 to 0.6; 0.6 to 1.1; 0.6 to 1; 0.6 to 0.9; 0.6 to 0.85; 0.6 to 0.8; 0.6 to 0.75; 0.6 to 0.7; 0.7 to 1.1; 0.7 to 1; 0.7 to 0.85; 0.7 to 0.9; 0.7 to 0.8; etc.

In an aspect, the disclosure provides a gypsum board comprising: a set gypsum core disposed between two cover sheets, the core formed from a core slurry comprising water, stucco, colloidal silica, and optionally silica fume. The gypsum board demonstrates at least one of the following: (i) a High Temperature Shrinkage (S) of 10% or less in the z direction when heated to 1560° F. (850° C.), according to ASTM C1795-15; (ii) a High Temperature Shrinkage (S) of 10% or less in the x-y directions (width-length) when heated to 1560° F. (850° C.) according to ASTM C1795-15; (iii) a Thermal Insulation Index (TI) of 20 minutes or greater according to ASTM C1795-15; (iv) a High Temperature Thickness Expansion in the z direction of at least 0.1% when thickness is evaluated according to the analogous techniques and methodology of ASTM C1795-15, and/or (v) where, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than 325° F. plus ambient temperature after at least 60 minutes; or an average value of the temperature sensors is less than 250° F. plus ambient temperature after at least 60 minutes.

The slurry for forming the set gypsum core of the board contains water, stucco, colloidal silica, and optional ingredients such as one or more of the following: silica fume, foaming agent, accelerator, retarder, strength-enhancing starch, migrating starch, polyphosphate, boric acid and/or salts of boric acid, tartaric acid and/or salts of tartaric acid, combinations thereof, and other components as desired. In some embodiments, the core slurry excludes an organic dispersant such as polynaphthalene sulfonate (PNS), lignosulfonate, and polycarboxylate (PCE) because, surprisingly and unexpectedly, the addition of colloidal silica into the gypsum slurry increases the fluidity without any impact on the setting time. However, if desired, in some embodiments, the core slurry optionally includes an organic dispersant. In some embodiments, the core slurry includes polynaphthalene sulfonate (PNS) and/or lignosulfonate but excludes polycarboxylate (PCE). If present in the core slurry, the polynaphthalene sulfonate (PNS) can be in any suitable amount, e.g., in an amount of at least 0.01% by weight of the stucco, such as from 0.1% to 2% by weight of the stucco, or from 0.05% to 1% by weight of the stucco. The lignosulfonate, if included, can be provided in any suitable amount, such as at least 0.01% by weight of the stucco, such as from 0.1% to 2% by weight of the stucco, or from 0.05% to 1% by weight of the stucco.

Stucco is sometimes referred to as calcined gypsum, and it can be in the form of calcium sulfate alpha hemihydrate, calcium sulfate beta hemihydrate, and/or calcium sulfate anhydrite. The calcined gypsum can be fibrous in some embodiments, nonfibrous in other embodiments, or a combination thereof in other embodiments. In embodiments, the calcined gypsum can include at least 50% beta calcium sulfate hemihydrate. In other embodiments, the calcined gypsum can include at least 86% beta calcium sulfate hemihydrate.

Colloidal silica is a water-based, stabilized dispersion of amorphous silicon dioxide (silica) nanoparticles. It can be produced, e.g., through the polymerization of silica nuclei derived from silicate solutions. It can be observed as tiny silica particles suspended in water, forming a generally stable, liquid-like solution. While conventionally colloidal silica is known as increasing viscosity in cementitious applications, the inventors have surprisingly and unexpectedly found that fluidity can be enhanced in the preparation of gypsum board. In this respect, the colloidal silica particles desirably have a negative or neutral surface charge because they surprisingly and unexpectedly have lower water demand and allow for the use of lower WSR. Steric groups can be employed to use functionality to achieve the desired charge and efficiency of colloidal silica. In some embodiments, the particles can be stabilized through the use of ions, such as sodium.

The use of both colloidal silica and silica fume in the fire-resistance wallboards has surprisingly and unexpectedly been found to reduce the WSR and control the thermal shrinkage, e.g., even in three-hour testing at 1000° C. (ASTM E119). Surprisingly, in some embodiments, dispersants (e.g. polynaphthalene sulfonate (PNS), lignosulfonate, and polycarboxylate (PCE)) can be reduced or eliminated from the core slurry.

The colloidal silica can have any desired specific gravity, specific surface area, and average particle diameter. In some embodiments, the colloidal silica has a specific gravity of from 1 g/cm³ to 1.5 g/cm³, such as from 1.1 g/cm³ to 1.4 g/cm³, or from 1.1 g/cm³ to 1.3 g/cm³. In some embodiments, the colloidal silica has a specific surface area from 20 to 1500 m2/kg. In some embodiments, the colloidal silica has an average particle diameter of 1 nm to 100 nm, from 5 nm to 60 nm, or from 10 nm to 30 nm, such as 20 nm. In some embodiments, the colloidal silica comprises amorphous particles containing a negative surface charge. In some embodiments, the amorphous silica particles carry a neutral surface charge.

In some embodiments, the colloidal silica comprises amorphous particles in a neutral, aqueous dispersion. In some embodiments, the colloidal silica comprises amorphous particles in an alkaline, aqueous dispersion. In some embodiments, wherein the colloidal silica comprises amorphous particles in an acidic, aqueous dispersion.

The dispersion can contain any suitable amount of solid colloidal silica. For example, in some embodiments, the dispersion contains from 20% to 40% solids by weight, such as from 25% to 35% solids by weight, e.g., 30% solids by weight. In some embodiments, the dispersion contains from 30% to 50% solids by weight, such as from 35% to 45% solids by weight, e.g., 40% solids by weight. In some embodiments, the dispersion contains from 30% to 55% solids by weight, such as from 35% to 45% solids by weight, e.g., 42% solids by weight. In some embodiments, the dispersion contains from 30% to 50% solids by weight, such as from 35% to 45% solids by weight, e.g., 40% solids by weight.

Table 1 depicts illustrative, representative types of colloidal silica, manufactured by Nouryon Chemicals, Amsterdam, the Netherlands.

TABLE 1

| | |
|---|---|
| Levasil CB25A | a neutral, aqueous dispersion of colloidal silica that is 30% solids |
| | by weight. The silica dispersion is sodium stabilized, and the |
| | amorphous silica particles carry a negative surface charge. |
| Levasil CB24 | an alkaline, aqueous dispersion of colloidal silica that is 40% |
| | solids by weight. The silica dispersion is sodium stabilized, and |
| | the amorphous silica particles carry a negative surface charge. |
| Levasil CS40-58 | a cationic acidic, aqueous dispersion of colloidal silica that is 42% |
| | solids by weight. The silica dispersion is aluminum oxide |
| | stabilized, and the amorphous silica particles carry a positive |
| | surface charge. |
| Levasil CS34- | an acidic, aqueous dispersion of colloidal silica that is 34% solids |
| 720P | by weight. The silica dispersion is stabilized by the absence of |
| | electrolytes and the amorphous silica particles carry a non- |
| | charged surface. |
| Levasil CS40- | an alkaline, aqueous dispersion of colloidal silica that is 40% |
| 620P | solids by weight. The silica dispersion is ammonia stabilized, and |
| | the amorphous silica particles carry a negative surface charge. |

The colloidal silica can be present in the core slurry, face skim coat slurry, and/or back skim coat slurry in any suitable amount, e.g., an amount of from 0.1% to 10% by weight of the stucco, such as from 0.5% to 8% by weight of the stucco, or from 0.8% to 10% by weight of the stucco, such as from 1% to 7% by weight of the stucco.

Silica fume (also referred to as microsilica or as “SF”) generally appears as a very fine powder, gray in color. Silica fume may be produced as a byproduct in the production of, e.g., silicon metal or alloys containing silicon (e.g., ferrosilicon alloys) in electric-arc furnaces.

With respect to its physical characteristics and chemical properties, silica fume consists primarily of amorphous silicon dioxide (SiO₂) in generally spherical particles. Silica fume is considered amorphous because, inter alia, silica fume is not a crystalline material. Generally, crystalline materials will not dissolve (e.g., sand). Silica fume particles are typically extremely small (e.g., more than 95% of silica fume particles can be less than 1 μm).

In embodiments, silica fume can be composed of 85% or more of SiO₂. In other embodiments, silica fume can contain various trace elements (based upon the type of fume produced). While SiO₂ can be considered the reactive material present in silica fume, various trace materials can also be present. The identification of these materials is based generally upon plant conditions including, e.g., which metal was produced in the electric-arc furnace where the silica fume was originally recovered. Generally, such latent materials are considered to have little to no impact on the performance of silica fume.

The silica fume can have any suitable average particle size, bulk density, specific gravity, and specific surface area. For example, in some embodiments, the silica fume is in the form of particles having an average particle diameter of from 0.05 to 3 μm, from 0.08 to 2 μm, or from 0.1 to 1 μm, such as 0.15 μm. In some embodiments, the silica fume is undensified and has a bulk density of from 150 to 450 kg/m³, such as from 180 to 350 kg/m³, or from 200 to 300 kg/m³. In some embodiments, the silica fume is densified and has a bulk density of from 400 to 800 kg/m³, 450 to 700 kg/m³, or from 550 to 650 kg/m³. In some embodiments, the silica fume has a specific gravity of from 1.5 g/cm³ to 3.0 g/cm³. In some embodiments, the silica fume has a specific surface area of from 15,000 to 30,000 m²/kg. For example, the specific surface area can be measured according to the Brunauer-Emmett-Teller (BET) method. As known in the art, the BET method is used, among other things, to measure the surface area of solid and/or porous materials, for example, as described in, e.g., U.S. Patent Publication 2020/00317537 A1.

Commercially available examples of silica fume include densified silica fume and undensified silica fume, respectively, produced by Norchem, Inc., headquartered in Hauppauge, New York, and Elkem Microsilica® 920 and Elkem Microsilica® 940, which is a densified silica fume, produced by Elkem ASA, headquartered in Oslo, Norway.

As understood in the art, silica fume is distinguished from “fumed silica” (sometimes referred to as pyrogenic silica) since the two materials demonstrate different chemical, physical, and performance properties. For example, silica fume and fumed silica are formed under different conditions and settings. As described above, silica fume may be collected as a byproduct in the production of, e.g., silicon metal or ferrosilicon alloys in electric-arc furnaces. Fumed silica (as referred to as pyrogenic silica) is produced in a flame. Thus, the structure and makeup of fumed silica differs from silica fume; for example, fumed silica may consist of microscopic droplets of amorphous silica fused into branched, chainlike, three-dimensional secondary particles. These particles, among other things, may agglomerate into tertiary particles. As a result, fumed silica is generally used for certain rheological applications (e.g., increasing the viscosity of slurries as a thickening or anticaking agent).

The silica fume can be added to the gypsum slurry in dry (e.g., powder) or wet (e.g., suspended or dissolved in a liquid medium) form(s), e.g., using a high shear mixer See, e.g., U.S. Patent Application U.S. patent application Ser. No. 18/749,520, incorporated herein by reference. In wet form (i.e., diluted form), the active content of the silica fume can be any suitable amount.

In accordance with aspects of the present disclosure, a silica slurry can be prepared separately from the gypsum slurry. The silica fume slurry can include, for example, dry densified silica fume mixed with water. In one embodiment, the slurry can comprise of 10-50% silica fume. In another embodiment, the slurry can comprise of 15-20% silica fume. It will be understood that efficiency of the silica fume is determined by normalizing the amount to the active content (e.g., when comparing a dry, i.e., 100%, form as compared with a wet, diluted form where the active content will be less than 100%).

For example, in some embodiments, the active content is 50% or less, e.g., 10%-50%; 15%-50%; 25%-45%; 30%-40%; etc. In some embodiments, the active content is 16.7%. It will be understood that efficiency of the silica fume is determined by normalizing the amount to the active content (e.g., when comparing a dry, i.e., 100%, form as compared with a wet, diluted form where the active content will be less than 100%).

In an aspect, a silica fume slurry is mixed prior to combining the silica fume with the core slurry. The silica fume slurry comprises silica fume particles and water. The silica fume slurry is then mixed into the core slurry.

In embodiments of the present disclosure, the silica fume slurry is prepared in a high shear mixer at an rpm of 2500. Examples of high shear mixers may include Ross high shear mixers, progressive cavity pumps, etc.

The colloidal silica and silica fume can be provided in any suitable weight ratio. For example, in some embodiments, the weight ratio of colloidal silica to silica fume is from 0.1/1 to 1/0.1, such as from 0.2/1 to 2/1, or from 0.4/1 to 4/1.

The silica fume is present in the core slurry, face skim coat slurry, and/or back skim coat slurry in an amount of from 1% to 10 wt. %, such as from 2% to 8%, from 3% to 7%, or from 4% to 6% by weight of the stucco.

Foaming agent can also be included in the core slurry to introduce air voids into the set gypsum core to reduce board weight. The foaming agent can be added by addition in a primary discharge conduit of the main board mixer. In some embodiments, the foaming agent comprises a major weight portion of unstable component, and a minor weight portion of stable component (e.g., where unstable and blend of stable/unstable are combined). The weight ratio of unstable component to stable component is effective to form an air void distribution within the set gypsum core. See, e.g., U.S. Pat. Nos. 5,643,510; 6,342,284; and 6,632,550. It has been found that suitable void distribution and wall thickness can be effective to enhance strength, especially in lower density board (e.g., 35 pcf or less). See, e.g., U.S. Pat. Nos. 9,802,866 and 9,840,066. Evaporative water voids, generally having voids of 5 μm or less in diameter, also contribute to the total void distribution along with the aforementioned air (foam) voids.

Strength-enhancing starch can optionally be included in the core slurry, face skim coat slurry, and/or back skim coat slurry. Such a starch improves the strength of the board (e.g., with respect to nail pull strength) as compared with the same board excluding the starch. Starches for strength enhancement are discussed in, e.g., U.S. Pat. Nos. 9,540,810, 9,828,441, 10,399,899, and 10,919,808. Any suitable strength-enhancing starch can be used, including hydroxyalkylated starches such as hydroxyethylated or hydroxypropylated starch, or a combination thereof; a pregelatinized starch; or an uncooked, non-migrating, starch.

Any suitable pregelatinized starch can be included in the core slurry, face skim coat slurry, and/or back skim coat slurry, as described in U.S. Pat. Nos. 10,399,899 and 9,828,441, including methods of preparation thereof and desired viscosity ranges described therein. If included, the pregelatinized starch can exhibit any suitable viscosity. In some embodiments, the pregelatinized starch is a mid-range viscosity starch as measured according to the VMA method as known in the art and as set forth in U.S. Pat. No. 10,399,899, which VMA method is hereby incorporated by reference. In other embodiments, the pregelatinized starch has a greater viscosity, such as greater than 700 centipoise (e.g., 773 centipoise) according to the VMA test.

In some embodiments, the starch includes an uncooked starch having (i) a hot water viscosity of from 20 BU to 300 BU according to the hot water viscosity assay (HWVA method), and/or (ii) a mid-range peak viscosity of from 120 BU to 1000 BU when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for 10 minutes, and the starch is cooled to 50° C. at a rate of −3° C./minute as described in U.S. Pat. No. 10,919,808.

For example, in some embodiments, the strength-enhancing starch includes an uncooked medium hydrolyzed acid modified starch (e.g., an uncooked acid-modified corn starch having a hot water viscosity of 180 BU); and/or a medium viscosity and medium molecular weight pregelatinized starch (e.g., pregelatinized corn flour starch with a cold water viscosity of 90 centipoise).

Strength-enhancing starches differ from migrating starches such as LC-211, commercially available from Archer-Daniels-Midland, Chicago, Illinois. Migrating starches normally have smaller chain lengths (e.g., due to acid- or enzyme-modification) and migrate to the core-cover sheet interface for further bond enhancement. For example, in some embodiments, the core slurry includes a migrating starch having a molecular weight of 6,000 Daltons or less.

If included, the optional strength-enhancing starch can be included in the core slurry, face skim coat slurry, and/or back skim coat slurry in any suitable amount. For example, in some embodiments, the core slurry, face skim coat slurry, and/or back skim coat slurry comprises a strength-enhancing starch in an amount of at least 0.5% by weight of the stucco (e.g., from 0.5% to 5% by weight of the stucco, such as from 0.5% to 3%, from 1% to 5%, from 1% to 3%, from 2% to 5%, from 2% to 4%, from 2% to 3%, by weight of the stucco, etc.). In some embodiments, the core slurry, face skim coat slurry, and/or back skim coat slurry is substantially free of a strength-enhancing starch, e.g., having 2% or less by weight of stucco, such as 1% or less by weight of the stucco.

The core slurry, face skim coat slurry, and/or back skim coat slurry can include accelerator and/or retarder. Accelerator (e.g., wet gypsum accelerator, heat resistant accelerator, climate stabilized accelerator) and retarder are well known and can be included in the core slurry, if desired. See, e.g., U.S. Pat. Nos. 3,573,947 and 6,409,825. In some embodiments where accelerator and/or retarder are included, the accelerator and/or retarder each can be in the core slurry in an amount on a solid basis of, such as, from 0% to 10% by weight of the stucco (e.g., 0.1% to 10%), such as, for example, from 0% to 5% by weight of the stucco (e.g., 0.1% to 5%).

Trimetaphosphate compounds can be used in the core slurry, face skim coat slurry, and/or back skim coat slurry e.g., in order to enhance sag resistance in the board. Examples include, for example, sodium trimetaphosphate, potassium trimetaphosphate, lithium trimetaphosphate, and ammonium trimetaphosphate.

With respect to the trimetaphosphate compound, the core slurry, face skim coat slurry, and/or back skim coat slurry can include it in any suitable amount, e.g., from 0.01% to 0.5% by weight of the stucco, from 0.01% to 0.4%; from 0.05% to 0.3%; from 0.1% to 0.5%; from 0.1% to 0.4%; from 0.1% to 0.3%; from 0.1% to 0.2%; from 0.15% to 0.5%; from 0.2% to 0.4%; from 0.05% to 0.5%; by weight of the stucco, etc.

Other additives for sag resistance properties can be included, such as boric acid and/or salts of boric acid, tartaric acid and/or salts of tartaric acid. In some embodiments, the tartaric acid is in the form of tartaric acid racemate. The boric acid and/or the salts of boric acid can be included optionally in the core slurry in a quantity of from 0.01% to 0.15%, e.g., 0.01% to 0.1% by weight of the stucco. The tartaric acid and/or the salts of tartaric acid can be included optionally in the core slurry in a quantity of from 0.001% to 0.1%, e.g., 0.005% to 0.03% by weight of the stucco. In some embodiments, the boric acid, salts of boric acid, tartaric acid, and/or salts of tartaric acid are included in the core slurry, face skim coat slurry, and/or back skim coat slurry for product used in humid environments. For example, in some embodiments, the boric acid, salts of boric acid, tartaric acid, and/or salts of tartaric acid can be used in climates or environments where the board is subjected to a dew point of at least 55° F. (13° C.), such as a dew point of at least 65° F. (18° C.), and/or in climates or environments where the board is subjected to relative humidity (RH) of at least 50%, e.g., at least 60% RH, on a regular basis such as for 1500 hours per year or more, e.g., 3000 hours per year or more.

The cover sheets can also have any suitable total thickness. In some embodiments, at least one of the cover sheets has a relatively high thickness, e.g., a thickness of at least 0.014 inches. In some embodiments, it is preferred that there is an even higher thickness, e.g., at least 0.015 inches, at least 0.016 inches, at least 0.017 inches, at least 0.018 inches, at least 0.019 inches, at least 0.020 inches, at least 0.021 inches, at least 0.022 inches, or at least 0.023 inches. Any suitable upper limit for these ranges can be adopted, e.g., an upper end of the range of 0.030 inches, 0.027 inches, 0.025 inches, 0.024 inches, 0.023 inches, 0.022 inches, 0.021 inches, 0.020 inches, 0.019 inches, 0.018 inches, etc. The total sheet thickness refers to the sum of the thickness of each sheet attached to the gypsum board.

The cover sheets can have any suitable density. For example, in some embodiments, at least one or both of the cover sheets has a density of at least 36 pcf, e.g., from 36 pcf to 46 pcf; such as from 36 pcf to 44 pcf; from 36 pcf to 42 pcf; from 36 pcf to 40 pcf; from 38 pcf to 46 pcf; from 38 pcf to 44 pcf; from 38 pcf to 42 pcf; etc.

The cover sheet can have any suitable weight. For example, in some embodiments, lower basis weight cover sheets (e.g., formed from paper) such as, for example, at least 33 lbs/MSF (e.g., from 33 lbs/MSF to 65 lbs/MSF, from 33 lbs/MSF to 60 lbs/MSF, 33 lbs/MSF to 58 lbs/MSF from 33 lbs/MSF to 55 lbs/MSF, from 33 lbs/MSF to 50 lbs/MSF, from 33 lbs/MSF to 45 lbs/MSF, etc., or less than 45 lbs/MSF) can be utilized in some embodiments. In other embodiments, one or both cover sheets has a basis weight from 38 lbs/MSF to 65 lbs/MSF, from 38 lbs/MSF to 60 lbs/MSF, from 38 lbs/MSF to 58 lbs/MSF, from 38 lbs/MSF to 55 lbs/MSF, from 38 lbs/MSF to 50 lbs/MSF, from 38 lbs/MSF to 45 lbs/MSF, etc.

However, if desired, in some embodiments, even heavier basis weights can be used, e.g., to further enhance nail pull resistance or to enhance handling, e.g., to facilitate desirable “feel” characteristics for end-users. Thus, one or both of the cover sheets can have a basis weight of, for example, at least 45 lbs/MSF (e.g., from 45 lbs/MSF to 65 lbs/MSF, from 45 lbs/MSF to 60 lbs/MSF, from 45 lbs/MSF to 55 lbs/MSF, from 50 lbs/MSF to 65 lbs/MSF, from 50 lbs/MSF to 60 lbs/MSF, etc.). If desired, in some embodiments, one cover sheet (e.g., the “face” paper side when installed) can have the aforementioned higher basis weight, e.g., to enhance nail pull resistance and handling, while the other cover sheet (e.g., the “back” sheet when the board is installed) can have somewhat lower weight basis if desired (e.g., weight basis of less than 60 lbs/MSF, e.g., from 33 lbs/MSF to 55 lbs/MSF, from 33 lbs/MSF to 50 lbs/MSF, from 33 lbs/MSF to 45 lbs/MSF, from 33 lbs/MSF to 40 lbs/MSF, etc.).

In some embodiments, the gypsum board can pass certain tests using a small scale bench test, in accordance with ASTM C1795-15, including high temperature shrinkage in the x-y directions (width-length), high temperature shrinkage (or even expansion) in the z-direction (thickness), and a Thermal Insulation Index (TI). Such bench tests are suitable for predicting the fire resistance performance of the gypsum board, e.g., in full scale tests under ASTM E119-09a for assemblies constructed under any of UL U305, U419, and/or U423 (2015 editions), and/or equivalent fire test procedures and standards. Passing the ASTM E119-09a test with the assembly of any one of these UL tests allows for a fire-rating. Briefly, UL U305 calls for wood studs in the assembly. UL U419 is a non-load bearing metal stud assembly, using 25-gauge studs. UL U423 is a load bearing metal stud assembly using 20-gauge studs. UL U419 is generally considered a more difficult test to pass than UL U305 or UL U423 because it uses light gauge steel studs that deform more easily than the studs used under UL U305 and UL U423.

In accordance with some embodiments, gypsum board is configured (e.g., as reduced weight and density, ⅝ inch thick gypsum panels) to meet or exceed a “one hour” fire rating pursuant to the fire containment and structural integrity requirements of assemblies constructed under one or more of UL U305, U419, and/or U423, using ASTM E119 and/or equivalent fire test procedures and standards. The present disclosure thus provides gypsum board (e.g., of reduced weight and density), and methods for making the same, that are capable of satisfying at least ¾-hour fire rating pursuant to the fire containment and structural integrity procedures and standards U419.

The gypsum board can be tested, e.g., in an assembly according to Underwriters Laboratories UL U305, U419, and U423 specifications and any other fire test procedure that is equivalent to any one of those fire test procedures. It should be understood that reference made herein to a particular fire test procedure of ASTM E-119 and using assemblies prepared in accordance with Underwriters Laboratories, such as, UL U305, U419, and U423, for example, also includes a fire test procedure, such as one promulgated by any other entity, that is equivalent to ASTM E119-09a and the particular UL standard in question.

Gypsum board according to some embodiments of the present disclosure is effective to withstand the hose stream test also conducted as part of the UL U305 procedures. In accordance with UL U305, gypsum board of some embodiments constructed in an assembly is subjected to fire endurance testing according to U305 for 30 minutes, at which time it is pulled from the heating environment and moved to another location for the hose stream test according to U305. The assembly is subjected to a stream of water from a fire hose equipped to send the water out at 30 psi water pressure for a sixty second duration.

By extension, gypsum board formed according to principles of some embodiments of the present disclosure can be used in assemblies that are effective to inhibit the transmission of heat there through to meet the one-hour fire-resistance rating to be classified as Type X board under ASTM 1396/C 1396M-06. In other embodiments, assemblies can be constructed using gypsum board formed according to principles of the present disclosure that conform to the specification of other UL assemblies, such as UL U419 and U423, for example. In yet other embodiments, gypsum board formed according to principles of the present disclosure can be used in other assemblies that are substantially equivalent to at least one of U305, U419, and U423. Such assemblies can pass the one-hour fire rating and applicable hose stream testing for U305, U419, U423, and other equivalent fire test procedures in accordance with some embodiments.

In some embodiments, the High Temperature Shrinkage according to ASTM C1795-15 of the gypsum board typically is 10% or less in the x-y directions (width-length), e.g., 8% or less, 6% or less, 4% or less, 2% or less, 1% or less, etc.

With respect to the thickness of the board, i.e., the z-direction, the board can shrink to a relatively small degree (e.g., 10% or less).

Thus, in some embodiments, the High Temperature Shrinkage of the gypsum board in the z-direction can be 10% or less, e.g., 9% or less, 8% or less, 7% or less, 5% or less, 3% or less, 2% or less, 1% or less, etc. For example, the High Temperature Shrinkage of the gypsum board in the z-direction can be from 0.1% to 10%, e.g., from 0.1% to 9%, from 0.1% to 8%, from 0.1% to 7%, from 0.1% to 5%, from 0.5% to 10%, from 0.5% to 5%, from 1% to 10%, from 1% to 8%, from 1% to 5%, from 5% to 10%, or from 5% to 8%.

With respect to gypsum board in accordance with some embodiments, board that has a High Temperature Shrinkage of 10% or less in the z direction that the board will pass one or more fire tests according to ASTM E119 using the assemblies constructed according to UL U305, U419, and U423, and the board will thus be fire-rated.

“Shrink resistance” is a measure of the proportion or percentage of the x-y (width-length) area of a whole board including face and back paper that remains after the core is heated to a defined temperature over a defined period of time (see, e.g., U.S. Pat. No. 3,616,173). In some embodiments, a gypsum board formed according to principles of some embodiments of the present disclosure, and the methods for making same, can provide a board that exhibits an average shrink resistance of 85% or greater (e.g., 90% or greater, or 95% or greater) when heated at 1560° F. (850° C.) for one hour in accordance with ASTM C1795-15. In other embodiments, the gypsum board exhibits an average shrink resistance of 75% or greater (e.g., 80% or greater) when heated at 1560° F. (850° C.) for one hour in accordance with ASTM C1795-15.

The gypsum layers between the cover sheets of some embodiments can be effective to provide a Thermal Insulation Index (TI) of 17 minutes or greater, e.g., 20 minutes or greater, in accordance with ASTM C1795-15. The gypsum layers can have any suitable density (D), e.g., as described herein. In some embodiments, the gypsum board has a reduced density, e.g., 40 pcf or less, 39 pcf or less, 38 pcf or less, 37 pcf or less, 36 pcf or less, 35 pcf or less, etc.). Some embodiments of the present disclosure allow for suitable fire resistance properties at such lower densities. The gypsum layers between the cover sheets can be effective in some embodiments to provide the gypsum board or any layer therein with a ratio of TI/D of 0.6 minutes/pounds per cubic foot (0.038 minutes/(kg/m3)) or more.

The board can have any desired thickness, such as from 0.25 inch to one inch (e.g., 0.25 inch, 0.375 inch, 0.5 inch, 0.625 inch, 0.75 inch, one inch, etc.). Desirably, the board has good strength as described herein, such as an average gypsum layer hardness of at least 11 pounds (5 kg), e.g., at least 13 pounds (5.9 kg), or at least 15 pounds (6.8 kg).

In some embodiments, the board has a nominal thickness of ⅝ inch. For example, the gypsum board in some embodiments is effective to inhibit the transmission of heat through an assembly constructed in accordance with any one of UL Design Numbers U305, U419 or U423, the assembly having a first side with a single layer of gypsum boards and a second side with a single layer of gypsum boards. ASTM E119-09a involves placing thermocouples in numerous places throughout a particular assembly. The thermocouples then monitor temperature as the assembly is exposed to heat over time. In this respect, surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a. ASTM E119 specifies that the assembly fails the test if any of the thermocouples exceeds a certain preset temperature (ambient plus 325° F.), or if the average of the temperatures from the thermocouples exceeds a different preset temperature (ambient plus 250° F.).

In some embodiments of gypsum board, when heated, the maximum single value of the temperature sensors is less than 325° F. plus ambient temperature after 50 minutes, and/or or the average value of the temperature sensors is less than 250° F. plus ambient temperature after 50 minutes. In some embodiments, the board has a density of 40 pounds per cubic foot or less.

In some embodiments, when the surfaces on the first side of the assembly of gypsum board are heated, the maximum single value of the temperature sensors is less than 325° F. plus ambient temperature after 55 minutes, and/or the average value of the temperature sensors is less than 250° F. plus ambient temperature after 55 minutes. In other embodiments, when the surfaces of gypsum board on the first side of the assembly are heated, the maximum single value of the temperature sensors is less than 325° F. plus ambient temperature after 60 minutes and/or the average value of the temperature sensors is less than 250° F. plus ambient temperature after 60 minutes. In other embodiments, when the surfaces of gypsum board on the first side of the assembly are heated, the maximum single value of the temperature sensors is less than 325° F. plus ambient temperature after 50 minutes, and/or the average value of the temperature sensors is less than 250° F. plus ambient temperature after 50 minutes. In other embodiments, when the surfaces of gypsum board on the first side of the assembly are heated, the maximum single value of the temperature sensors is less than 325° F. plus ambient temperature after 55 minutes, and/or the average value of the temperature sensors is less than 250° F. plus ambient temperature after 55 minutes. In other embodiments, when the surfaces of gypsum board on the first side of the assembly are heated, the maximum single value of the temperature sensors is less than 325° F. plus ambient temperature after 60 minutes, and the average value of the temperature sensors is less than 250° F. plus ambient temperature after 60 minutes.

In some embodiments, the gypsum board is effective to inhibit the transmission of heat through the assembly when constructed in accordance with UL Design Number U305 so as to achieve a one-hour fire rating under ASTM E119-09a. In some embodiments, the board is effective to inhibit the transmission of heat through the assembly when constructed in accordance with UL Design Number U419 so as to achieve a one-hour fire rating under ASTM E119-09a. In some embodiments, the gypsum board is effective to inhibit the transmission of heat through the assembly when constructed in accordance with UL Design Number U423 so as to achieve a one-hour fire rating under ASTM E119-09a. In some embodiments, the board has a Thermal Insulation Index (TI) of 20 minutes or greater and/or a High Temperature Shrinkage (S) of 10% or less, in accordance with ASTM C1795-15. In some embodiments, the board has a ratio of High Temperature Thickness Expansion (TE) to S (TEIS) of 0.06 or more, such as 0.2 or more.

In some embodiments, the gypsum board has a High Temperature Shrinkage (S) of 10% or less in the x-y direction when heated to 1560° F. (850° C.), according to ASTM C1795-15, and/or a High Temperature Shrinkage (S) of 10% or less in the z direction when heated to 1560° F. (850° C.), according to ASTM C1795-15.

In some embodiments, the gypsum board has a Thermal Insulation Index (TI) of 20 minutes or greater according to ASTM C1795-15, and/or a High Temperature Thickness Expansion in the z direction of at least 0.1% when thickness is evaluated according to the analogous techniques and methodology of ASTM C1795-15.

In some embodiments, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than 325° F. plus ambient temperature after at least 60 minutes; or an average value of the temperature sensors is less than 250° F. plus ambient temperature after at least 60 minutes. In some embodiments, a maximum single value of the temperature sensors is less than 325° F. plus ambient temperature after 60 minutes; or an average value of the temperature sensors is less than 250° F. plus ambient temperature after 60 minutes. In some embodiments, a maximum single value of the temperature sensors is less than 325° F. plus ambient temperature after 120 minutes; or an average value of the temperature sensors is less than 250° F. plus ambient temperature after 120 minutes. In some embodiments, a maximum single value of the temperature sensors is less than 325° F. plus ambient temperature after 60 minutes; or an average value of the temperature sensors is less than 250° F. plus ambient temperature after 180 minutes.

Board can be made with different dimensions, depending on, e.g., product type and market. The board can have any suitable width (e.g., 48 inches to 54 inches), length (e.g., 96 inches to 192 inches), and thickness (e.g., ¼ inch, ⅜ inch, ½ inch, ⅝ inch, ¾ inch, 1 inch, etc.). Dimensions in different markets can vary slightly as well understood in the art.

Board weight is a function of the thickness of the board. Since boards are commonly made at varying thicknesses, board density is used herein as a measure of board weight. Examples of suitable nominal thickness include ¼ inch, ⅜ inch, ½ inch, ⅝ inch, ¾ inch, or one inch, and any range using any of the foregoing as endpoints. In some markets, the board can be formed at a nominal thickness according to metric measurements, e.g., 9 mm, 9.5 mm, 10 mm, 12 mm, 12.5 mm, 13 mm, 15 mm, 25 mm, and any range using any of the foregoing as endpoints. Properties referenced herein can be seen in board formed at one or more of the previously mentioned board thicknesses according to various embodiments. The advantages of the gypsum board in accordance with embodiments of the disclosure can be seen at a range of densities, including up to heavier board densities, e.g., 43 pcf or less, or 40 pcf or less, such as from 17 pcf to 43 pcf, from 20 pcf to 43 pcf, from 24 pcf to 43 pcf, from 27 pcf to 43 pcf, from 20 pcf to 40 pcf, from 24 pcf to 40 pcf, from 27 pcf to 40 pcf, from 20 pcf to 37 pcf, from 24 pcf to 37 pcf, from 27 pcf to 37 pcf, from 20 pcf to 35 pcf, from 24 pcf to 35 pcf, from 27 pcf to 35 pcf, etc.

The dense layer(s) has a considerably greater density than the density of the board core. For example, the dense layer can have a density of from 40 pcf to 70 pcf (e.g., from 45 pcf to 65 pcf, or from 50 pcf to 60 pcf).

The core can have any suitable density, but lesser densities can be used, e.g., a core density of 35 pcf or less (e.g., 31 pcf or less, or 27 pcf or less). For example, the core can have a density of from 15 pcf to 35 pcf (e.g., from 20 pcf to 31 pcf, from 20 pcf to 24 pcf, or from 24 pcf to 27 pcf, etc.). However, if desired higher core densities can be employed, e.g., from 35 pcf to 65 pcf, such as from 35 pcf to 60 pcf, from 35 pcf to 55 pcf, from 35 pcf to 50 pcf, from 40 pcf to 60 pcf, from 40 pcf to 50 pcf, from 45 pcf to 60 pcf, or from 45 pcf to 55 pcf, etc.

Arrangements for producing the board are described in, e.g., U.S. Pat. Nos. 5,683,635; 6,494,609; 6,874,930; and 7,364,676 and U.S. Patent Application Publications 2010/0247937; 2012/0168527; and 2012/0170403.

The board can be prepared in any suitable manner. In embodiments, a main mixer containing an agitator as understood in the art is used at a wet end of a manufacturing line as also understood in the art. The agitator can be in the form of pins, disk, impeller, propeller, rotor spinning inside a stationary housing, or the like. The main mixer can be used to prepare a core and dense slurry, respectively. Stucco, water, and optionally, an additive package are inserted into the main mixer. The mixer contains a primary discharge conduit and a secondary discharge conduit. Slurry is discharged from the primary discharge conduit where core additives such as foam (see, e.g., U.S. Pat. No. 5,683,635) are inserted to form a core slurry. Slurry can be released from the secondary discharge conduit to form a dense layer slurry (e.g., with less or no foaming agent as compared with the core slurry).

Thus, in an aspect, the disclosure provides a method of making gypsum board. The method comprises mixing a core slurry comprising stucco, water, colloidal silica, and optionally silica fume. The method further comprises placing the slurry between two cover sheets to form a board precursor and allowing the slurry in the precursor to set to form the board. The board is cut, and the gypsum board exhibits at least one of the following: (i) a High Temperature Shrinkage (S) of 10% or less in the z direction when heated to 1560° F. (850° C.), according to ASTM C1795-15; (ii) a High Temperature Shrinkage (S) of 10% or less in the x-y directions (width-length) when heated to 1560° F. (850° C.) according to ASTM C1795-15; (ii) a Thermal Insulation Index (TI) of 20 minutes or greater according to ASTM C1795-15; (iv) a High Temperature Thickness Expansion in the z direction of at least 0.1% when thickness is evaluated according to the analogous techniques and methodology of ASTM C1795-15, and/or (v) where, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than 325° F. plus ambient temperature after at least 60 minutes; or an average value of the temperature sensors is less than 250° F. plus ambient temperature after at least 60 minutes.

In embodiments, the silica fume is mixed into the core slurry in the form of the silica fume slurry, e.g., prepared in a densified or undensified type of silica fume. For example, the silica fume slurry is mixed under high shear mixers or rotor stator mixers in some embodiments. The colloidal silica can be provided in the form of a colloidal silica slurry.

This disclosure is further illustrated by the following exemplary aspects. However, the disclosure is not limited by the following aspects.
(1) A gypsum board or method of preparing board, as described herein.
(2) A gypsum board comprising: a set gypsum core disposed between two cover sheets, the core formed from a core slurry comprising water, stucco, colloidal silica, and silica fume; and the gypsum board having at least one of the following items (a)-(e): (a) a High Temperature Shrinkage (S) of 10% or less in the z direction when heated to 1560° F. (850° C.), according to ASTM C1795-15; (b) a High Temperature Shrinkage (S) of 10% or less in the x-y directions (width-length) when heated to 1560° F. (850° C.) according to ASTM C1795-15; (c) a Thermal Insulation Index (TI) of 20 minutes or greater according to ASTM C1795-15; (d) a High Temperature Thickness Expansion in the z direction of at least 0.1% when thickness is evaluated according to the analogous techniques and methodology of ASTM C1795-15, and/or; (e) where, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than 325° F. plus ambient temperature after at least 60 minutes; or an average value of the temperature sensors is less than 250° F. plus ambient temperature after at least 60 minutes.
(3) The gypsum board of aspect 2, wherein the core slurry has a water to stucco ratio of 1.1 or less, such as from 0.4 to 1.0, or from 0.3 to 0.8, or from 0.5 to 0.75.
(4) The gypsum board of aspect 2, wherein the core slurry has a water to stucco ratio of 1.1 or less, such as from 0.4 to 1.0, or from 0.3 to 0.8, or from 0.5 to 0.75.
(5) The gypsum board of aspect 4, wherein the core slurry optionally includes polynaphthalene sulfonate (PNS) in an amount of at least 0.01% by weight of the stucco, such as from 0.1% to 2% by weight of the stucco, or from 0.05% to 1% by weight of the stucco.
(6) The gypsum board of aspects 4 or 5, wherein the core slurry optionally includes lignosulfonate in an amount of at least 0.01% by weight of the stucco, such as from 0.1% to 2% by weight of the stucco, or from 0.05% to 1% by weight of the stucco.
(7) The gypsum board of aspects 2 or 3, wherein the core slurry excludes an organic dispersant.
(8) The gypsum board of aspect 7, wherein the core slurry excludes polynaphthalene sulfonate (PNS), lignosulfonate, and polycarboxylate (PCE).
(9) The gypsum board of any one of aspects 2-8, wherein the silica fume is in the form of particles having an average particle diameter of from 0.05 to 3 μm, from 0.08 to 2 μm, or from 0.1 to 1 μm, such as 0.15 μm.
(10) The gypsum board of any one of aspects 2-9, wherein the silica fume is undensified and has a bulk density of from 150 to 450 kg/m3, such as from 180 to 350 kg/m3, or from 200 to 300 kg/m3.
(11) The gypsum board of any one of aspects 2-9, wherein the silica fume is densified and has a bulk density of from 400 to 800 kg/m3, 450 to 700 kg/m3, or from 550 to 650 kg/m3.
(12) The gypsum board of any one of aspects 2-11, wherein the silica fume has a specific gravity of from 1.5 g/cm3 to 3.0 g/cm3.
(13) The gypsum board of any one of aspects 2-12, wherein the silica fume has a specific surface area measured in accordance with the BET method of from 15,000 to 30,000 m2/kg.
(14) The gypsum board of any one of aspects 2-13, wherein the colloidal silica has an average particle diameter of from 1 nm to 100 nm, from 5 nm to 60 nm, or from 10 nm to 30 nm, such as 20 nm.
(15) The gypsum board of any one of aspects 2-14, wherein the colloidal silica has a specific gravity of from 1 g/cm3 to 1.5 g/cm3, such as from 1.1 g/cm3 to 1.4 g/cm3, or from 1.1 g/cm3 to 1.3 g/cm3.
(16) The gypsum board of any one of aspects 2-15, wherein the colloidal silica has a specific surface area from 20 to 1500 m2/kg.
(17) The gypsum board of any one of aspects 2-16, wherein the colloidal silica has an average particle diameter of 1 nm to 100 nm, from 5 nm to 60 nm, or from 10 nm to 30 nm, such as 20 nm.
(18) The gypsum board of any one of aspects 2-17, wherein the colloidal silica comprises amorphous particles in a neutral, aqueous dispersion.
(19) The gypsum board of aspect 18, wherein the amorphous silica particles carry a negative or neutral surface charge.
(20) The gypsum board of aspects 18 or 19, wherein the dispersion contains from 20% to 50% solids by weight, such as from 20% to 40%, or 25% to 35% solids by weight, e.g., 30% solids by weight.
(21) The gypsum board of any one of aspects 2-20, wherein the colloidal silica comprises amorphous particles in an alkaline, aqueous dispersion.
(22) The gypsum board of aspect 21, wherein the amorphous silica particles carry a negative or neutral surface charge.
(23) The gypsum board of aspects 21 or 22, wherein the dispersion contains from 20% to 50% solids by weight, such as from 30% to 50%, or 35% to 45% solids by weight, e.g., 40% solids by weight.
(24) The gypsum board of any one of aspects 2-23, wherein the colloidal silica comprises amorphous particles in an acidic, aqueous dispersion.
(25) The gypsum board of aspect 24, wherein the amorphous silica particles carry a negative or neutral surface charge.
(26) The gypsum board of aspects 24 or 25, wherein the dispersion contains from 20% to 55% solids by weight, such as from 30% to 55%, or 35% to 45% solids by weight, e.g., 42% solids by weight.
(27) The gypsum board of any one of aspects 2-26, wherein the colloidal silica comprises amorphous particles in an alkaline, aqueous dispersion.
(28) The gypsum board of aspect 27, wherein the amorphous silica particles carry a negative surface charge.
(29) The gypsum board of aspects 27 or 28, wherein the dispersion contains from 20% to 50% solids by weight, such as from 30% to 50%, or 35% to 45% solids by weight, e.g., 40% solids by weight.
(30) The gypsum board of any one of aspects 2-29, wherein the weight ratio of colloidal silica to silica fume is from 0.1/1 to 1/0.1, such as from 0.2/1 to 2/1, or from 0.4/1 to 4/1.
(31) The gypsum board of any one of aspects 2-30, wherein the colloidal silica is present in the core slurry in an amount of from 0.1% to 10% by weight of the stucco, such as from 0.5% to 8% by weight of the stucco, or from 0.8% to 10% by weight of the stucco, such as from 1% to 7% by weight of the stucco.
(32) The gypsum board of any one of aspects 2-31, wherein the silica fume is present in the core slurry in an amount of from 1% to 10% by weight of the stucco, such as from 2% to 8% by weight of the stucco, or from 3% to 7% by weight of the stucco, or from 4% to 6% by weight of the stucco.
(33) The gypsum board of any one of aspects 2-32, wherein the gypsum board has a High Temperature Shrinkage (S) of 10% or less in the x-y direction when heated to 1560° F. (850° C.), according to ASTM C1795-15.
(34) The gypsum board of any one of aspects 2-33, wherein the gypsum board has a High Temperature Shrinkage (S) of 10% or less in the z direction when heated to 1560° F. (850° C.), according to ASTM C1795-15.
(35) The gypsum board of any one of aspects 2-34, wherein the gypsum board has a Thermal Insulation Index (TI) of 20 minutes or greater according to ASTM C1795-15.
(36) The gypsum board of any one of aspects 2-35, wherein the gypsum board has a High Temperature Thickness Expansion in the z direction of at least 0.1% when thickness is evaluated according to the analogous techniques and methodology of ASTM C1795-15.
(37) The gypsum board of any one of aspects 2-36, wherein, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than 325° F. plus ambient temperature after at least 60 minutes; or an average value of the temperature sensors is less than 250° F. plus ambient temperature after at least 60 minutes.
(38) The gypsum board of aspect 37, wherein the maximum single value of the temperature sensors is less than 325° F. plus ambient temperature after 60 minutes; or an average value of the temperature sensors is less than 250° F. plus ambient temperature after 60 minutes.
(39) The gypsum board of aspect 37, wherein the maximum single value of the temperature sensors is less than 325° F. plus ambient temperature after 120 minutes; or an average value of the temperature sensors is less than 250° F. plus ambient temperature after 120 minutes.
(40) The gypsum board of aspect 37, wherein the maximum single value of the temperature sensors is less than 325° F. plus ambient temperature after 60 minutes; or an average value of the temperature sensors is less than 250° F. plus ambient temperature after 180 minutes.
(41) A method of making gypsum board, the method comprising: mixing a core slurry comprising stucco, water, colloidal silica, and silica fume; placing the slurry between two cover sheets to form a board precursor; allowing the slurry in the precursor to set to form the board; and cutting the board, the gypsum board having at least one of the following items (a)-(e): (a) a High Temperature Shrinkage (S) of 10% or less in the z direction when heated to 1560° F. (850° C.), according to ASTM C1795-15; (b) a High Temperature Shrinkage (S) of 10% or less in the x-y directions (width-length) when heated to 1560° F. (850° C.) according to ASTM C1795-15; (c) a Thermal Insulation Index (TI) of 20 minutes or greater according to ASTM C1795-15; (d) a High Temperature Thickness Expansion in the z direction of at least 0.1% when thickness is evaluated according to the analogous techniques and methodology of ASTM C1795-15, and/or; (e) where, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than 325° F. plus ambient temperature after at least 60 minutes; or an average value of the temperature sensors is less than 250° F. plus ambient temperature after at least 60 minutes.
(42) The method of aspect 41, wherein the silica fume is mixed into the core slurry in the form of the silica fume slurry, e.g., prepared in a densified or undensified type of silica fume.
(43) The method of any one of aspects 41-42, wherein the core slurry has a water to stucco ratio of 1.1 or less, such as from 0.6 to 1.1, or from 0.5 to 0.9, or from 0.3 to 1.
(44) The method of any one of aspects 41-43, wherein the core slurry (a) includes polynaphthalene sulfonate (PNS) and/or lignosulfonate, and (b) excludes polycarboxylate (PCE).
(45) The method of aspect 44, wherein the core slurry optionally includes polynaphthalene sulfonate (PNS), for example, in an amount of at least 0.01% by weight of the stucco, such as from 0.1% to 2% by weight of the stucco, or from 0.05% to 1% by weight of the stucco.
(46) The method of aspects 44 or 45, wherein the core slurry optionally includes lignosulfonate, for example, in an amount of at least 0.01% by weight of the stucco, such as from 0.1% to 2% by weight of the stucco, or from 0.05% to 1% by weight of the stucco.
(47) The method of any one of aspects 41-46, wherein the core slurry excludes an organic dispersant.
(48) The method of aspect 47, wherein the core slurry excludes polynaphthalene sulfonate (PNS), lignosulfonate, and polycarboxylate (PCE).
(49) The method of any one of aspects 41-48, wherein the silica fume is in the form of particles having an average particle diameter of from 0.05 to 3 μm, from 0.08 to 2 μm, or from 0.1 to 1 μm, such as 0.15 μm.
(50) The method of any one of aspects 41-49, wherein the silica fume is undensified and has a bulk density of from 150 to 450 kg/m3, such as from 180 to 350 kg/m3, or from 200 to 300 kg/m3.
(51) The method of any one of aspects 41-50, wherein the silica fume is densified and has a bulk density of from 400 to 800 kg/m3, 450 to 700 kg/m3, or from 550 to 650 kg/m3.
(52) The method of any one of aspects 41-51, wherein the silica fume has a specific gravity of from 1.5 g/cm3 to 3.0 g/cm3.
(53) The method of any one of aspects 41-52, wherein the silica fume has a specific surface area measured in accordance with the BET method of from 15,000 to 30,000 m2/kg.
(54) The method of any one of aspects 41-53, wherein the colloidal silica has an average particle diameter of from 1 nm to 100 nm, from 5 nm to 60 nm, or from 10 nm to 30 nm, such as 20 nm.
(55) The method of any one of aspects 41-54, wherein the colloidal silica has a specific gravity of from 1 g/cm3 to 1.5 g/cm3, such as from 1.1 g/cm3 to 1.4 g/cm3, or from 1.1 g/cm3 to 1.3 g/cm3.
(56) The method of any one of aspects 41-55, wherein the colloidal silica has a specific surface area from 20 to 1500 m2/kg.
(57) The method of any one of aspects 41-56, wherein the colloidal silica has an average particle diameter of 1 nm to 100 nm, from 5 nm to 60 nm, or from 10 nm to 30 nm, such as 20 nm.
(58) The method of any one of aspects 41-57, wherein the colloidal silica comprises amorphous particles in a neutral, aqueous dispersion.
(59) The method of aspect 58, wherein the amorphous silica particles carry a negative or neutral surface charge.
(60) The method of aspects 58 or 59, wherein the dispersion contains from 20% to 50% solids by weight, such as from 20% to 40%, or 25% to 35% solids by weight, e.g., 30% solids by weight.
(61) The method of any one of aspects 41-60, wherein the colloidal silica comprises amorphous particles in an alkaline, aqueous dispersion.
(62) The method of aspect 61, wherein the amorphous silica particles carry a negative or neutral surface charge.
(63) The method of aspects 61 or 62, wherein the dispersion contains from 20% to 50% solids by weight, such as from 30% to 50%, or 35% to 45% solids by weight, e.g., 40% solids by weight.
(64) The method of any one of aspects 41-63, wherein the colloidal silica comprises amorphous particles in an acidic, aqueous dispersion.
(65) The method of aspect 64, wherein the amorphous silica particles carry a negative or neutral surface charge.
(66) The method of aspects 64 or 65, wherein the dispersion contains from 20% to 55% solids by weight, such as from 30% to 55%, or 35% to 45% solids by weight, e.g., 42% solids by weight.
(67) The method of any one of aspects 41-66, wherein the colloidal silica comprises amorphous particles in an alkaline, aqueous dispersion.
(68) The method of aspect 67, wherein the amorphous silica particles carry a negative surface charge.
(69) The method of aspects 67 or 68, wherein the dispersion contains from 20% to 50% solids by weight, such as from 30% to 50%, or 35% to 45% solids by weight, e.g., 40% solids by weight.
(70) The method of any one of aspects 41-69, wherein the weight ratio of colloidal silica to silica fume is from 0.1/1 to 1/0.1, such as from 0.2/1 to 2/1, or from 0.4/1 to 4/1.
(71) The method of any one of aspects 41-70, wherein the colloidal silica is present in the core slurry in an amount of from 0.1% to 10% by weight of the stucco, such as from 0.5% to 8% by weight of the stucco, or from 0.8% to 10% by weight of the stucco, such as from 1% to 7% by weight of the stucco.
(72) The method of any one of aspects 41-71, wherein the silica fume is present in the core slurry in an amount of from 1% to 10% by weight of the stucco, such as from 2% to 8% by weight of the stucco, or from 3% to 7% by weight of the stucco, or from 4% to 6% by weight of the stucco.
(73) The method of any one of aspects 41-72, wherein the gypsum board has a High Temperature Shrinkage (S) of 10% or less in the x-y direction when heated to 1560° F. (850° C.), according to ASTM C1795-15.
(74) The method of any one of aspects 41-73, wherein the gypsum board has a High Temperature Shrinkage (S) of 10% or less in the z direction when heated to 1560° F. (850° C.), according to ASTM C1795-15.
(75) The method of any one of aspects 41-74, wherein the gypsum board has a Thermal Insulation Index (TI) of 20 minutes or greater according to ASTM C1795-15.
(76) The method of any one of aspects 41-75, wherein the gypsum board has a High Temperature Thickness Expansion in the z direction of at least 0.1% when thickness is evaluated according to the analogous techniques and methodology of ASTM C1795-15.
(77) The method of any one of aspects 41-76, wherein, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than 325° F. plus ambient temperature after at least 60 minutes; or an average value of the temperature sensors is less than 250° F. plus ambient temperature after at least 60 minutes.
(78) The method of aspect 77, wherein a maximum single value of the temperature sensors is less than 325° F. plus ambient temperature after 60 minutes; or an average value of the temperature sensors is less than 250° F. plus ambient temperature after 60 minutes.
(79) The method of aspect 77, wherein the maximum single value of the temperature sensors is less than 325° F. plus ambient temperature after 120 minutes; or an average value of the temperature sensors is less than 250° F. plus ambient temperature after 120 minutes.
(80) The method of aspect 77, wherein the maximum single value of the temperature sensors is less than 325° F. plus ambient temperature after 60 minutes; or an average value of the temperature sensors is less than 250° F. plus ambient temperature after 180 minutes.
(81) A gypsum board comprising: face and back cover sheets; a board core disposed between the face and back cover sheets, the core comprising set gypsum formed from a core slurry comprising water, stucco, and colloidal silica and an optional silica fume; a back skim coat layer defining first and second back skim coat faces, the back skim coat formed from a back skim coat slurry comprising water, stucco, silica fume and an optional colloidal silica; the back skim coat disposed in bonding relation to the core, the first face of the back skim coat layer facing the back cover sheet, and the second face of the back skim coat layer facing the board core, a face skim coat layer defining first and second face skim coat faces, the face skim coat formed from a face skim coat slurry comprising water, stucco, silica fume and an optional colloidal silica; the face skim coat disposed in bonding relation to the core, the first face of the face skim coat layer facing the face cover sheet, and the second face of the face skim coat layer facing the board core, wherein the back skim coat slurry and the face skim coat slurry can be the same or different; wherein the silica fume is present in the core slurry in an amount of from 0% to 8% by weight of the stucco, such as from 1% to 7% by weight of the stucco, or from 2% to 6% by weight of the stucco, or from 3% to 5% by weight of the stucco; and the silica fume is present in the back skim coat layer or the face skim coat layer in an amount of from 2% to 12% by weight of the stucco, such as from 3% to 10% by weight of the stucco, or from 4% to 8% by weight of the stucco, or from 5% to 7% by weight of the stucco; and wherein the silica fume present in the back skim coat slurry and the face skim coat slurry can be the same or different.
(82) The gypsum board of aspects 81, wherein the core slurry has a water to stucco ratio of 1.1 or less, such as from 0.4 to 1.0, or from 0.3 to 0.8, or from 0.5 to 0.75.
(83) The gypsum board of any one of aspects 81-82, wherein the core slurry (a) includes polynaphthalene sulfonate (PNS) and/or lignosulfonate, and (b) excludes polycarboxylate (PCE).
(84) The gypsum board of aspect 83, wherein the core slurry optionally includes polynaphthalene sulfonate (PNS) in an amount of at least 0.01% by weight of the stucco, such as from 0.1% to 2% by weight of the stucco, or from 0.05% to 1% by weight of the stucco.
(85) The gypsum board of aspects 83 or 84, wherein the core slurry optionally includes lignosulfonate in an amount of at least 0.01% by weight of the stucco, such as from 0.1% to 2% by weight of the stucco, or from 0.05% to 1% by weight of the stucco.
(86) The gypsum board of any one of aspects 81-85, wherein the core slurry excludes an organic dispersant.
(87) The gypsum board of aspect 84, wherein the core slurry excludes polynaphthalene sulfonate (PNS), lignosulfonate, and polycarboxylate (PCE).
(88) The gypsum board of any one of aspects 81-87, wherein the silica fume is in the form of particles having an average particle diameter of from 0.05 to 3 μm, from 0.08 to 2 μm, or from 0.1 to 1 μm, such as 0.15 μm.
(89) The gypsum board of any one of aspects 81-88, wherein the silica fume is undensified and has a bulk density of from 150 to 450 kg/m3, such as from 180 to 350 kg/m3, or from 200 to 300 kg/m3.
(90) The gypsum board of any one of aspects 81-89, wherein the silica fume is densified and has a bulk density of from 400 to 800 kg/m3, 450 to 700 kg/m3, or from 550 to 650 kg/m3.
(91) The gypsum board of any one of aspects 81-90, wherein the silica fume has a specific gravity of from 1.5 g/cm3 to 3.0 g/cm3.
(92) The gypsum board of any one of aspects 81-91, wherein the silica fume has a specific surface area measured in accordance with the BET method of from 15,000 to 30,000 m2/kg.
(93) The gypsum board of any one of aspects 81-92, wherein the colloidal silica has an average particle diameter of from 1 nm to 100 nm, from 5 nm to 60 nm, or from 10 nm to 30 nm, such as 20 nm.
(94) The gypsum board of any one of aspects 81-93, wherein the colloidal silica has a specific gravity of from 1 g/cm3 to 1.5 g/cm3, such as from 1.1 g/cm3 to 1.4 g/cm3, or from 1.1 g/cm3 to 1.3 g/cm3.
(95) The gypsum board of any one of aspects 81-94, wherein the colloidal silica has a specific surface area from 20 to 1500 m2/kg.
(96) The gypsum board of any one of aspects 81-95, wherein the colloidal silica has an average particle diameter of 1 nm to 100 nm, from 5 nm to 60 nm, or from 10 nm to 30 nm, such as 20 nm.
(97) The gypsum board of any one of aspects 81-96, wherein the colloidal silica comprises amorphous particles in a neutral, aqueous dispersion.
(98) The gypsum board of aspect 97, wherein the amorphous silica particles carry a negative or neutral surface charge.
(99) The gypsum board of aspects 97 or 98, wherein the dispersion contains from 20% to 50% solids by weight, such as from 20% to 40%, or 25% to 35% solids by weight, e.g., 30% solids by weight.
(100) The gypsum board of any one of aspects 81-99, wherein the colloidal silica comprises amorphous particles in an alkaline, aqueous dispersion.
(101) The gypsum board of aspect 100, wherein the amorphous silica particles carry a negative or neutral surface charge.
(102) The gypsum board of aspects 100 or 101, wherein the dispersion contains from 20% to 50% solids by weight, such as from 30% to 50%, or 35% to 45% solids by weight, e.g., 40% solids by weight.
(103) The gypsum board of any one of aspects 81-102, wherein the colloidal silica comprises amorphous particles in an acidic, aqueous dispersion.
(104) The gypsum board of aspect 103, wherein the amorphous silica particles carry a negative or neutral surface charge.
(105) The gypsum board of aspects 103 or 104, wherein the dispersion contains from 20% to 55% solids by weight, such as from 30% to 55%, or 35% to 45% solids by weight, e.g., 42% solids by weight.
(106) The gypsum board of any one of aspects 81-105, wherein the colloidal silica comprises amorphous particles in an alkaline, aqueous dispersion.
(107) The gypsum board of aspect 106, wherein the amorphous silica particles carry a negative surface charge.
(108) The gypsum board of aspects 106 or 107, wherein the dispersion contains from 20% to 50% solids by weight, such as from 30% to 50%, or 35% to 45% solids by weight, e.g., 40% solids by weight.
(109) The gypsum board of any one of aspects 81-108, wherein the weight ratio of colloidal silica to silica fume is from 0.1/1 to 1/0.1, such as from 0.2/1 to 2/1, or from 0.4/1 to 4/1.
(110) The gypsum board of any one of aspects 81-109, wherein the colloidal silica is present in the core slurry in an amount of from 0.1% to 10% by weight of the stucco, such as from 0.5% to 8% by weight of the stucco, or from 0.8% to 10% by weight of the stucco, such as from 1% to 7% by weight of the stucco.
(111) The gypsum board of any one of aspects 81-110, wherein the silica fume is present in the core slurry in an amount of from 1% to 10% by weight of the stucco, such as from 2% to 8% by weight of the stucco, or from 3% to 7% by weight of the stucco, or from 4% to 6% by weight of the stucco.
(112) The gypsum board of any one of aspects 81-111, wherein the gypsum board has a High Temperature Shrinkage (S) of 10% or less in the x-y direction when heated to 1560° F. (850° C.), according to ASTM C1795-15.
(113) The gypsum board of any one of aspects 81-112, wherein the gypsum board has a High Temperature Shrinkage (S) of 10% or less in the z direction when heated to 1560° F. (850° C.), according to ASTM C1795-15.
(114) The gypsum board of any one of aspects 81-113, wherein the gypsum board has a Thermal Insulation Index (TI) of 20 minutes or greater according to ASTM C1795-15.
(115) The gypsum board of any one of aspects 81-114, wherein the gypsum board has a High Temperature Thickness Expansion in the z direction of at least 0.1% when thickness is evaluated according to the analogous techniques and methodology of ASTM C1795-15.
(116) The gypsum board of any one of aspects 81-115, wherein, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than 325° F. plus ambient temperature after at least 60 minutes; or an average value of the temperature sensors is less than 250° F. plus ambient temperature after at least 60 minutes.
(117) The gypsum board of aspect 116, wherein the maximum single value of the temperature sensors is less than 325° F. plus ambient temperature after 60 minutes; or an average value of the temperature sensors is less than 250° F. plus ambient temperature after 60 minutes.
(118) The gypsum board of aspect 116, wherein the maximum single value of the temperature sensors is less than 325° F. plus ambient temperature after 120 minutes; or an average value of the temperature sensors is less than 250° F. plus ambient temperature after 120 minutes.
(119) The gypsum board of aspect 116, wherein the maximum single value of the temperature sensors is less than 325° F. plus ambient temperature after 60 minutes; or an average value of the temperature sensors is less than 250° F. plus ambient temperature after 180 minutes.
(120) A gypsum board comprising: a set gypsum core disposed between two cover sheets, the core formed from a core slurry comprising water, stucco, colloidal silica, and silica fume; the gypsum board having a High Temperature Shrinkage (S) of 10% or less in the x-y directions (width-length) when heated to 1560° F. (850° C.), according to ASTM C1795-15.
(121) The gypsum board of aspect 120, wherein the core slurry excludes polynaphthalene sulfonate (PNS), lignosulfonate, and polycarboxylate (PCE), and the core slurry has a water to stucco ratio of 1.1 or less, such as from 0.4 to 1.1, 0.4 to 1.0, or from 0.3 to 0.8, or from 0.5 to 0.75.
(122) The gypsum board of aspects 120 or 121, wherein the colloidal silica has an average particle diameter particle diameter of from 1 nm to 100 nm, from 5 nm to 60 nm, or from 10 nm to 30 nm, such as 20 nm, a specific gravity of from 1 g/cm³ to 1.5 g/cm³, such as from 1.1 g/cm³ to 1.4 g/cm³, or from 1.1 g/cm³ to 1.3 g/cm³, and a specific surface area from 20 to 1500 m2/kg.
(123) The gypsum board of any one of aspects 120-122, wherein the colloidal silica comprises amorphous particles in an aqueous dispersion, and wherein the amorphous silica particles carry a negative or neutral surface charge.
(124) The gypsum board of aspect 123, wherein the dispersion contains from 20% to 55% solids by weight, such as from 30% to 50%, or 35% to 45% solids by weight, e.g., 40% solids by weight.
(125) The gypsum board of any one of aspects 120-124, wherein the colloidal silica is present in the core slurry in an amount of from 0.1% to 10% by weight of the stucco, such as from 0.5% to 8% by weight of the stucco, or from 0.8% to 10% by weight of the stucco, such as from 1% to 7% by weight of the stucco, and wherein the silica fume is present in the core slurry in an amount of from 1% to 10% by weight of the stucco, such as from 2% to 8% by weight of the stucco, or from 3% to 7% by weight of the stucco, or from 4% to 6% by weight of the stucco.
(126) The gypsum board of any one of aspects 120-125, wherein the gypsum board has a Thermal Insulation Index (TI) of 20 minutes or greater according to ASTM C1795-15, and/or wherein, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than 325° F. plus ambient temperature after at least 60 minutes; or an average value of the temperature sensors is less than 250° F. plus ambient temperature after at least 60 minutes.
(127) A method of making gypsum board, the method comprising: mixing a core slurry comprising stucco, water, colloidal silica, and silica fume; placing the slurry between two cover sheets to form a board precursor; allowing the slurry in the precursor to set to form the board; and cutting the board; the gypsum board having a High Temperature Shrinkage (S) of 10% or less in the x-y directions (width-length) when heated to 1560° F. (850° C.), according to ASTM C1795-15.
(128) The method of aspect 127, wherein the silica fume is mixed into the core slurry in the form of the silica fume slurry, prepared using a densified or undensified type of silica fume.
(129) The method of aspects 127 or 128, wherein the core slurry excludes an organic dispersant, and wherein the core slurry has a water to stucco ratio of 1.1 or less, such as from 0.4 to 1.1, 0.6 to 1.1, or from 0.5 to 0.9, or from 0.3 to 1.
(130) The method of any one of aspects 127-129, wherein: the colloidal silica comprises amorphous particles in an aqueous dispersion, the amorphous silica particles carry a negative or neutral surface charge, and the dispersion contains from 20% to 55% solids by weight, such as from 30% to 55%, or 35% to 45% solids by weight, e.g., 42% solids by weight.
(131) The method of any one of aspects 127-130, wherein: the colloidal silica is present in the core slurry in an amount of from 0.1% to 10% by weight of the stucco, such as from 0.5% to 8% by weight of the stucco, or from 0.8% to 10% by weight of the stucco, such as from 1% to 7% by weight of the stucco; the silica fume is present in the core slurry in an amount of from 1% to 10% by weight of the stucco, such as from 2% to 8% by weight of the stucco, or from 3% to 7% by weight of the stucco, or from 4% to 6% by weight of the stucco; the core slurry, face skim coat slurry, and/or back skim coat slurry contain a sag resistance additive comprising at least one of the following: sodium trimetaphosphate, boric acid and/or salts of boric acid, tartaric acid and/or salts of tartaric acid; the core slurry, face skim coat slurry, and/or back skim coat slurry contain a strength-enhancing starch, including at least one of the following: a hydroxyethylated or hydroxypropylated starch, a pregelatinized starch (e.g., a medium viscosity and medium molecular weight pregelatinized starch), an uncooked, non-migrating starch, (e.g., an uncooked starch having (i) a hot water viscosity of from 20 BU to 300 BU according to the hot water viscosity assay (HWVA method), and/or (ii) a mid-range peak viscosity of from 120 BU to 1000 BU when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for 10 minutes, and the starch is cooled to 50° C. at a rate of −3° C./minute, an uncooked medium hydrolyzed acid modified starch), and/or a medium viscosity and medium molecular weight pregelatinized starch; and the board has a High Temperature Shrinkage of 10% or less in the x-y directions (width-length) according to ASTM C1795-15 when tested after three hours according to the time-temperature curve of ASTM E119-09a.
(132) The method of any one of aspects 127-131, the gypsum board having: a High Temperature Shrinkage (S) of 10% or less in the z direction when heated to 1560° F. (850° C.) according to ASTM C1795-15, a Thermal Insulation Index (TI) of 20 minutes or greater according to ASTM C1795-15, a High Temperature Thickness Expansion in the z direction of at least 0.1% when thickness is evaluated according to the analogous techniques and methodology of ASTM C1795-15, and/or where, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than 325° F. plus ambient temperature after at least 60 minutes; or an average value of the temperature sensors is less than 250° F. plus ambient temperature after at least 60 minutes.
(133) A gypsum board comprising: face and back cover sheets; a board core disposed between the face and back cover sheets, the core comprising set gypsum formed from a core slurry comprising water, stucco, and colloidal silica and an optional silica fume; a back skim coat layer defining first and second back skim coat faces, the back skim coat formed from a back skim coat slurry comprising water, stucco, an optional silica fume and an optional colloidal silica; the back skim coat disposed in bonding relation to the core, the first face of the back skim coat layer facing the back cover sheet, and the second face of the back skim coat layer facing the board core, a face skim coat layer defining first and second face skim coat faces, the face skim coat formed from a face skim coat slurry comprising water, stucco, an optional silica fume and an optional colloidal silica; the face skim coat disposed in bonding relation to the core, the first face of the face skim coat layer facing the face cover sheet, and the second face of the face skim coat layer facing the board core, wherein the back skim coat slurry and the face skim coat slurry can be the same or different; wherein the silica fume is present in the core slurry in an amount of from 0% to 10% by weight of the stucco, such as from 1% to 8% by weight of the stucco, such as from 0.5% to 8% by weight of the stucco, 3% to 8% by weight of the stucco, or from 2% to 6% by weight of the stucco, or from 3% to 5% by weight of the stucco, and the colloidal silica is present in the core slurry in an amount of from 0.1% to 10% by weight of the stucco, such as from; 0.5% to 8% by weight of the stucco, from 0.8% to 8% by weight of the stucco, from 1% to 7% by weight of the stucco, from 1% to 5% by weight of the stucco, from 3% to 6% by wight of the stucco, etc. the silica fume is present in the back skim coat slurry and/or the face skim coat slurry in an amount of from 0% to 12% by weight of the stucco, such as from 2% to 12% by weight of the stucco, or from 3% to 10% by weight of the stucco, and the colloidal silica is present in the back skim coat layer or face skim coat layer in an amount of from 0% to 12% by weight of the stucco, such as from 4% to 8%, by weight of the stucco, or from 5% to 7% by weight of the stucco; and wherein the gypsum board has a High Temperature Shrinkage (S) of 10% or less in the x-y directions (width-length) when heated to 1560° F. (850° C.), according to ASTM C1795-15.
(134) The gypsum board of aspect 133, wherein the silica fume is present in the back skim coat slurry and/or face skim coat slurry in an amount of 3% to 12% by weight of the stucco.
(135) The gypsum board of aspects 133 or 134, wherein the silica fume is present in the back skim coat slurry.
(136) The gypsum board of any one of aspects 133-135, wherein the colloidal silica is present in the face skim coat slurry or back skim coat slurry in an amount of 1% to 12% by weight of the stucco.
(137) The gypsum board of any one of aspects 133-136, wherein the silica fume is added to the core slurry and optionally the face and/or back skim coat slurries via a silica fume slurry containing 10-50% silica fume and water.
(138) The gypsum board of any one of aspects 133-137, wherein: the core slurry excludes polynaphthalene sulfonate (PNS), lignosulfonate, polycarboxylate (PCE); the silica fume is in the form of particles having an average particle diameter of from 0.05 to 3 μm (e.g., from 0.08 to 2 μm, or from 0.1 to 1 μm, such as 0.15 μm), the silica fume has a bulk density of from 150 to 800 kg/m3 (e.g., from 150 to 450 kg/m³, such as from 180 to 350 kg/m³, or from 200 to 300 kg/m³), a specific gravity of from 1.5 g/cm3 to 3.0 g/cm3, and a specific surface area measured in accordance with the BET method of from 15,000 to 30,000 m2/kg; the colloidal silica has an average particle diameter of from 5 nm to 60 nm (e.g., from 10 nm to 30 nm, such as 20 nm), a specific gravity of from 1 g/cm3 to 1.5 g/cm3 (e.g., from 1.1 g/cm³ to 1.4 g/cm³, or from 1.1 g/cm³ to 1.3 g/cm³), and a specific surface area from 20 to 1500 m2/kg; the colloidal silica comprises amorphous particles in an aqueous dispersion and the amorphous silica particles carry a negative or neutral surface charge and the dispersion contains from 20% to 55% solids by weight (e.g., from 25% to 35% solids by weight, such as 30% solids by weight); the core slurry, face skim coat slurry, and/or back skim coat slurry contain strength-enhancing starch, including at least one of the following: a hydroxyethylated or hydroxypropylated starch, a pregelatinized starch (e.g., a medium viscosity and medium molecular weight pregelatinized starch), an uncooked, non-migrating starch (e.g., an uncooked starch having (i) a hot water viscosity of from 20 BU to 300 BU according to the hot water viscosity assay (HWVA method), and/or (ii) a mid-range peak viscosity of from 120 BU to 1000 BU when the viscosity is measured by putting the starch in a slurry with water at a starch concentration of 15% solids, and using a Viscograph-E instrument set at 75 rpm and 700 cmg, where the starch is heated from 25° C. to 95° C. at a rate of 3° C./minute, the slurry is held at 95° C. for 10 minutes, and the starch is cooled to 50° C. at a rate of −3° C./minute, an uncooked medium hydrolyzed acid modified starch); the core slurry, face skim coat slurry, and/or back skim coat slurry contain a sag resistance additive comprising at least one of the following: sodium trimetaphosphate, boric acid and/or salts of boric acid, tartaric acid and/or salts of tartaric acid; and the core slurry has a water to stucco ratio of from 0.4 to 1.1 (e.g., from 0.4 to 1, or from 0.3 to 0.8, or from 0.5 to 0.75).
(139) The gypsum board of any one of aspects 133-138, wherein the board has at least one of the following items (a)-(d): (a) a High Temperature Shrinkage (S) of 10% or less in the z direction when heated to 1560° F. (850° C.) according to ASTM C1795-15, (b) a Thermal Insulation Index (TI) of 20 minutes or greater according to ASTM C1795-15, (c) a High Temperature Thickness Expansion in the z direction of at least 0.1% when thickness is evaluated according to the analogous techniques and methodology of ASTM C1795-15, and/or (d) where, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than 325° F. plus ambient temperature after at least 60 minutes; or an average value of the temperature sensors is less than 250° F. plus ambient temperature after at least 60 minutes.

It shall be noted that the preceding aspects are illustrative and not limiting. Other exemplary combinations are apparent from the entirety of the description herein. It will also be understood by one of ordinary skill in the art that various embodiments may be used in various combinations with the other embodiments provided herein.

The following examples further illustrate the disclosure but, of course, should not be construed as in any way limiting its scope.

### Example 1

This example demonstrates the efficiency of various commercially available colloidal silicas as water reducing agents. The colloidal silicas were evaluated using the slump fluidity spread testing method.

Four colloidal silica products were evaluated. The products are branded as Levasil products, manufactured by Nouryon Chemicals, Amsterdam, the Netherlands. Levasil CB25A is PH neutral aqueous dispersion of colloidal silica with a negative surface charge. Levasil CB24 is an alkaline pH dispersion of colloidal silica with a negative surface charge. Levasil CS40-58 is an acidic pH dispersion of colloidal silica with a positive surface charge. Levasil CS40-620P is an alkaline pH dispersion of colloidal silica with a negative surface charge.

A slurry composed of 400 g of hemihydrate, 4 g of ball mill accelerator, 0.4 g of sodium trimetaphosphate (STMP) and 4 g of pregelatinized starch, retarder (Versenex 80 from Dow Chemical, Midland, MI), water, and colloidal silica were mixed together in a high shear blender, poured into a cylinder, and allowed to spread. The resulting patty size was then measured by size and length of time needed to stiffen. Stiffening time was determined by cutting the slurry with a needle and observing when the walls of the cut no longer closed.

The water and retarder dosage in each formulation was adjusted until the slurry in each reached a patty size of 6.5 to 8 inches and stiffening time of 45 to 55 seconds.

Table 2 depicts the results of the final WSR and retarder dosage.

TABLE 2

| Colloidal | | Colloidal Silica Dosage (relative to stucco) | | | | |
|---|---|---|---|---|---|---|
| Silica | | 0 | 0.50% | 1% | 2% | 5% |
| Levasil | WSR (%) | 96.3 | 96.4 | 93.0 | 87.3 | 71.9 |
| CB25A | Retarder (%) | 0.055 | 0.055 | 0.052 | 0.050 | 0.050 |
| Levasil | WSR (%) | 96.3 | 96.4 | 92.9 | 87.1 | 83.6 |
| CB24 | Retarder (%) | 0.055 | 0.055 | 0.052 | 0.050 | 0.047 |
| Levasil | WSR (%) | 96.3 | 96.9 | 96.8 | 97.0 | 97.3 |
| CS40-58 | Retarder (%) | 0.055 | 0.060 | 0.060 | 0.062 | 0.065 |
| Levasil | WSR (%) | 96.3 | 93.0 | 89.4 | 83.8 | 80.3 |
| CS40-620P | Retarder (%) | 0.055 | 0.055 | 0.055 | 0.55 | 0.55 |

Table 2 depicts the results of different concentrations of colloidal silica on water reduction. As seen in Table 2, the inventors discovered that, surprisingly and unexpectedly, negatively charged dispersions of colloidal silica reduced the water needed to maintain the same slurry fluidity. The positive surface charge colloidal silica did not reduce the water needed to maintain the slurry fluidity.

In some embodiments, in the absence of regular organic dispersants (PNS, lignosulfonate, PCE), the addition of colloidal silica into the gypsum slurry increases the fluidity without any impact on the setting time. In embodiments, negatively charged colloidal silica are used inasmuch as they allow for decreasing the water demand in comparison to the use of positively charged particles (Levasil CS40-58) where the slurry is thickened. For instance, the WSR drops from 97% to 60% by using 10 wt. % Levasil CB25A colloidal silica.

### Example 2

This example demonstrates the efficiency of various commercially available colloidal silicas when used with PNS dispersant as water reducing agents. The water reduction was evaluated using the slump fluidity spread testing method as described in Example 1.

Five colloidal silica products manufactured by Nouryon were evaluated. Levasil CB25A is PH neutral aqueous dispersion of colloidal silica with a negative surface charge. Levasil CB24 is an alkaline pH dispersion of colloidal silica with a negative surface charge. Levasil CS40-58 is an acidic pH dispersion of colloidal silica with a positive surface charge. Levasil CS40-620P is an alkaline pH dispersion of colloidal silica with a negative surface charge. Levasil CS34-720 is an alkaline pH dispersion of colloidal silica with a non-charged surface.

A slurry composed of 400 g of hemihydrate, 4 g of ball mill accelerator, 0.4 g of STMP, 4 g of pregelatinized starch and 2 g of Durasar, (a polynaphthalene sulfonate manufactured by Ruetgers Polymers, Candiac, Quebec), retarder (Versenex 80 from Dow), water, and colloidal silica is mixed together in a high shear blender, poured into a cylinder, and allowed to spread. The water reduction was evaluated using the slump fluidity spread testing method as described in Example 1.

Table 3 depicts the results of the final WSR and retarder dosage.

TABLE 3

| Colloidal | | Colloidal Silica Dosage (relative to stucco) | | | | |
|---|---|---|---|---|---|---|
| Silica | | 0 | 0.50% | 1.25% | 2.5% | 5% |
| Levasil | WSR (%) | 87.2 | 86.1 | 81.0 | 74.8 | 69.6 |
| CB25A | Retarder (%) | 0.055 | 0.055 | 0.052 | 0.050 | 0.050 |
| Levasil | WSR (%) | 87.2 | 85.0 | 80.2 | 75.6 | — |
| CB24 | Retarder (%) | 0.055 | 0.055 | 0.052 | 0.050 | — |
| Levasil | WSR (%) | 87.2 | 87.3 | 87.5 | 87.6 | — |
| CS40-58 | Retarder (%) | 0.055 | 0.060 | 0.060 | 0.062 | — |
| Levasil | WSR (%) | 83.6 | — | 76.7 | 72.6 | 70.3 |
| CS40-620P | Retarder (%) | 0.055 | — | 0.055 | 0.055 | 0.055 |
| Levasil | WSR (%) | 83.6 | — | 79.5 | 73.0 | 67.2 |
| CS34-720 | Retarder (%) | 0.052 | — | 0.055 | 0.055 | 0.057 |

Table 3 depicts the results of different concentrations of colloidal silica on water reduction when using PNS as a dispersant. As seen in Table 3, the inventors discovered that, surprisingly and unexpectedly, all negative surface charge and non-charged surface colloidal silica dispersions reduced the water needed to maintain the same slurry fluidity in the presence of PNS. Positively charged colloidal silica did not reduce the water needed to maintain the same slurry fluidity.

### Example 3

This example demonstrates the efficiency of Levasil CB25A, which is a negatively charged neutral pH dispersion of colloidal silica commercially available from Nouryon, on water reduction when used with different dispersants. The dispersants tested include traditional dispersants for gypsum slurries, such as Marasperse GNS, which is a calcium lignosulfonate manufactured by Borregaard ASA, Sarpsborg, Norway, Ultrazine NA, which is a sodium lignosulfonate manufactured by Borregaard, and Mighty 21ES, which is a polycarboxylate ether manufactured by KAO Chemicals, Tokyo, JP.

A slurry composed of 400 g of hemihydrate, 4 g of ball mill accelerator, 0.4 g of STMP, 4 g of pregelatinized starch and the commercially available dispersant, retarder (Versenex 80 from Dow), water, and colloidal silica were mixed in a high shear blender, poured into a cylinder and allowed to spread. The water reduction was evaluated using the slump fluidity spread testing method as described in Example 1.

Table 4 depicts the results of the final WSR and retarder dosage.

TABLE 4

| Commercial | | Levasil CB25A Dosage | | | |
|---|---|---|---|---|---|
| Dispersant (dosage %) | | 0 | 1% | 2.5% | 5% |
| Marasperse GNS (0.5 | WSR (%) | 93.6 | 86.8 | 77.8 | 67.3 |
| %) | Retarder | 0.052 | 0.052 | 0.055 | 0.058 |
| | (%) | | | | |
| Ultrazine NA (0.5%) | WSR (%) | 88.6 | 80.9 | 75.0 | 68.0 |
| | Retarder | 0.052 | 0.052 | 0.05 | 0.05 |
| | (%) | | | | |
| Mighty 21ES (0.5%) | WSR (%) | 74.1 | — | 87.5 | — |
| | Retarder | 0.065 | — | 0.062 | — |
| | (%) | | | | |

Table 4 depicts the results of Levasil CB25A on water reduction when using different dispersants. As seen in Table 4, the inventors discovered that, surprisingly and unexpectedly, Levasil CB25A is capable of reducing the water needed to maintain the desired slurry fluidity in the presence of both lignosulfonate dispersants but causes slurry thickening in the presence of PCE dispersants.

### Example 4

This example demonstrates the shrinkage testing of four sample boards, identified as Boards Z, A, B, and C, respectively.

Board Z was prepared as a control, i.e., without the addition of silica fume and colloidal silica to the formulation. Board A was prepared with 8% of silica fume slurry (Elkem, EMSAC 500) commercially available from Elkem ASA, Oslo, Norway. Board B was prepared with 5% of silica fume slurry (EMSAC 500) and 2.5% of colloidal silica Levasil CB25A commercially available from Nouryon. Board C was prepared with 3% of silica fume slurry (EMSAC 500) and 5% of Levasil CB25A colloidal silica. The percentage of silica fume or colloidal silica is calculated as a percentage of the amount of stucco.

The boards were prepared from slurries comprising 900 g of hemihydrate, 9 g of ball mill accelerator, 0.2 g of STMP, 4 g of pregelatinized starch and 6 g of Durasar, (a polynaphthalene sulfonate manufactured by Ruetgers), retarder (Versenex 80 from Dow), water, 5 g glass fiber, and foam needed to maintain the same board weight. The boards' weight (measured in lbs/msf) were in the range of 2120 and 2160 lbs/MSF. The boards had a thickness of ⅝″ and dimensions of 12″×13″.

All powders and liquids were mixed in a 5-Quarter Hobart mixer, commercially available from Hobart Corporation, headquartered in Troy, Ohio. The slurry was prepared by soaking dry powders in the solution for 10 seconds and mixing for 10 seconds in the 5-Quarter Hobart mixer set at level 2, followed by injecting the desired amount of foam into the slurry and mixing another 2 seconds. The slurry was poured into the 12″×13″×⅝″ envelope. After the slurry was set and hardened, the samples were dried at 110° F. overnight.

Table 5 depicts the results of board shrinkage after drying overnight.

TABLE 5

| | | 8% | 5% SF + | 3% SF + |
|---|---|---|---|---|
| | Control | SF | 2.5% CS | 5% CS |
| Sample ID | Z | A | B | C |
| Stucco (g) | 900 | 900 | 900 | 900 |
| HRA (g) | 9 | 9 | 9 | 9 |
| Starch (g) | 4 | 4 | 4 | 4 |
| Glass Fiber (g) | 5 | 5 | 5 | 5 |
| STMP (g) | 0.2 | 0.2 | 0.2 | 0.2 |
| Retarder (g) | 0.08 | 0.08 | 0.08 | 0.09 |
| Dispersant (g) | 6 | 6 | 6 | 6 |
| EMSAC 500 | 0 | 72 | 45 | 27 |
| (50% solid) (g) | | | | |
| Colloidal silica, CB25A | 0 | 0 | 22.5 | 45 |
| (33% solid) (g) | | | | |
| Total water (g) | 819 | 815.7 | 738 | 685.7 |
| WSR | 91 | 90.6 | 82 | 76.2 |
| Water reduction (WSR %) | Control | 0.44% | 8.20% | 15.90% |

From Table 5, it is observed that the water stucco ratio (WSR) decreases with an increase in the amount of colloidal silica. The addition of 5% colloidal silica in sample D reduced the WSR by 15.9% as compared to the control sample Z.

Once dried, the boards were then cut into 5″×2″×⅝″ portions. A thermal shrinkage test was then conducted on the sample by placing them in the furnace for 1 hour following ASTM E119 heating curve.

Table 6 depicts the results of thermal shrinkage testing on Boards, Z, A, B, and C.

TABLE 6

| | Board | | | |
|---|---|---|---|---|
| Sample | Weight | Shrinkage % | | |
| ID | (lbs/MSF) | Length | Width | Thickness |
| Z | 2137 | −5.46% | −6.40% | −12.14% |
| A | 2125 | −1.99% | −2.99% | −6.53% |
| B | 2151 | −1.97% | −2.86% | −6.25% |
| C | 2159 | −2.27% | −3.03% | −5.79% |

Table 6 depicts shrinkage in terms of length (measured as percentage), wide (measured as percentage), and thickness (measured as percentage). As seen in Table 6, the inventors discovered that, surprisingly and unexpectedly, the combination of silica fume and colloidal silica improves board shrinkage.

The introduction of colloidal silica into the gypsum formulation has been shown to improve the efficiency of PNS and lignosulfonate-based dispersants. In contrast, the adsorption of colloidal silica on the surface of PCEs hinders the performance of the dispersants, not showing any water reduction. Moreover, colloidal silica with smaller particle size can enhance efficiency in water reduction.

As shown, the use of both colloidal silica and silica fume is beneficial in controlling thermal shrinkage and demonstrates good performance for one-hour and three-hour testing following an ASTM E119 heating curve. The usage of both colloidal silica and silica fume in the gypsum formulation also provides a benefit with respect to water reduction. A ⅝″ board made from 2.5 wt. % colloidal silica and 6 wt. % silica fume shows similar thermal shrinkage to that of 8 wt. % silica fume while reducing water by 8%.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A gypsum board comprising:
a set gypsum core disposed between two cover sheets, the core formed from a core slurry comprising water, stucco, colloidal silica, and silica fume; the gypsum board having a High Temperature Shrinkage (S) of 10% or less in the x-y directions (width-length) when heated to 1560° F. (850° C.), according to ASTM C1795-15.

2. The gypsum board of claim 1, wherein the core slurry excludes polynaphthalene sulfonate (PNS), lignosulfonate, and polycarboxylate (PCE), and the core slurry has a water to stucco ratio of from 0.4 to 1.1.

3. The gypsum board of claim 1, wherein the colloidal silica has an average particle diameter of from 1 nm to 100 nm, a specific gravity of from 1 g/cm³ to 1.5 g/cm³, and a specific surface area from 20 to 1500 m2/kg.

4. The gypsum board of claim 1, wherein the colloidal silica comprises amorphous particles in an aqueous dispersion, and wherein the amorphous silica particles carry a negative or neutral surface charge.

5. The gypsum board of claim 4, wherein the dispersion contains from 20% to 55% solids by weight.

6. The gypsum board of claim 1, wherein the colloidal silica is present in the core slurry in an amount of from 0.1% to 10% by weight of the stucco, and wherein the silica fume is present in the core slurry in an amount of from 1% to 10% by weight of the stucco.

7. The gypsum board of claim 1, wherein the gypsum board has a Thermal Insulation Index (TI) of 20 minutes or greater according to ASTM C1795-15, and/or
wherein, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than 325° F. plus ambient temperature after at least 60 minutes; or an average value of the temperature sensors is less than 250° F. plus ambient temperature after at least 60 minutes.

8. A method of making gypsum board, the method comprising:
(a) mixing a core slurry comprising stucco, water, colloidal silica, and silica fume;
(b) placing the slurry between two cover sheets to form a board precursor;
(c) allowing the slurry in the precursor to set to form the board; and
(d) cutting the board;
the gypsum board having a High Temperature Shrinkage (S) of 10% or less in the x-y directions (width-length) when heated to 1560° F. (850° C.), according to ASTM C1795-15.

9. The method of claim 8, wherein the silica fume is mixed into the core slurry in the form of the silica fume slurry, prepared using a densified or undensified type of silica fume.

10. The method of claim 8, wherein the core slurry excludes an organic dispersant, and wherein the core slurry has a water to stucco ratio of from 0.4 to 1.1.

11. The method of claim 10, wherein the colloidal silica comprises amorphous particles in an aqueous dispersion, the amorphous silica particles carry a negative or neutral surface charge, and the dispersion contains from 20% to 55% solids by weight.

12. The method of claim 11, wherein:
the colloidal silica is present in the core slurry in an amount of from 0.1% to 10% by weight of the stucco,
the silica fume is present in the core slurry in an amount of from 1% to 10% by weight of the stucco,
the core slurry, face skim coat slurry, and/or back skim coat slurry contain a sag resistance additive comprising at least one of the following: sodium trimetaphosphate, boric acid and/or salts of boric acid, tartaric acid and/or salts of tartaric acid,
the core slurry, face skim coat slurry, and/or back skim coat slurry contain a strength-enhancing starch comprising a hydroxyethylated or hydroxypropylated starch, a pregelatinized starch, or an uncooked, non-migrating starch, and
the board has a High Temperature Shrinkage of 10% or less in the x-y directions (width-length) according to ASTM C1795-15 when tested after three hours according to the time-temperature curve of ASTM E119-09a.

13. The method of claim 12, the gypsum board having:
(i) a High Temperature Shrinkage (S) of 10% or less in the z direction when heated to 1560° F. (850° C.) according to ASTM C1795-15,
(ii) a Thermal Insulation Index (TI) of 20 minutes or greater according to ASTM C1795-15,
(iii) a High Temperature Thickness Expansion in the z direction of at least 0.1% when thickness is evaluated according to the analogous techniques and methodology of ASTM C1795-15, and/or
(iv) where, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than 325° F. plus ambient temperature after at least 60 minutes; or an average value of the temperature sensors is less than 250° F. plus ambient temperature after at least 60 minutes.

14. A gypsum board comprising:
(a) face and back cover sheets;
(b) a board core disposed between the face and back cover sheets, the core comprising set gypsum formed from a core slurry comprising water, stucco, and colloidal silica and an optional silica fume;
(c) a back skim coat layer defining first and second back skim coat faces, the back skim coat formed from a back skim coat slurry comprising water, stucco, an optional silica fume and an optional colloidal silica; the back skim coat disposed in bonding relation to the core, the first face of the back skim coat layer facing the back cover sheet, and the second face of the back skim coat layer facing the board core,
(d) a face skim coat layer defining first and second face skim coat faces, the face skim coat formed from a face skim coat slurry comprising water, stucco, an optional silica fume and an optional colloidal silica; the face skim coat disposed in bonding relation to the core, the first face of the face skim coat layer facing the face cover sheet, and the second face of the face skim coat layer facing the board core, wherein the back skim coat slurry and the face skim coat slurry can be the same or different; wherein
(e) the silica fume is present in the core slurry in an amount of from 0% to 10% by weight of the stucco and the colloidal silica is present in the core slurry in an amount of from 0.1% to 10% by weight of the stucco;
(f) the silica fume is present in the back skim coat slurry and/or the face skim coat slurry in an amount of from 0% to 12% by weight of the stucco, and the colloidal silica is present in the back skim coat layer or face skim coat layer in an amount of from 0.1% to 12% by weight of the stucco; and
wherein the gypsum board has a High Temperature Shrinkage (S) of 10% or less in the x-y directions (width-length) when heated to 1560° F. (850° C.), according to ASTM C1795-15.

15. The gypsum board of claim 14, wherein the silica fume is present in the back skim coat slurry and/or face skim coat slurry in an amount of 3% to 12% by weight of the stucco.

16. The gypsum board of claim 15, wherein the silica fume is present in the back skim coat slurry.

17. The gypsum board of claim 14, wherein the colloidal silica is present in the face skim coat slurry or back skim coat slurry in an amount of 1% to 12% by weight of the stucco.

18. The gypsum board of claim 14, wherein the silica fume is added to the core slurry and optionally the face and/or back skim coat slurries via a silica fume slurry containing water and 10-50% silica fume.

19. The gypsum board of claim 14, wherein:
the core slurry excludes polycarboxylate (PCE),
the silica fume is in the form of particles having an average particle diameter of from 0.05 to 3 μm, a bulk density of from 150 to 800 kg/m³, a specific gravity of from 1.5 g/cm³ to 3.0 g/cm³, and a specific surface area measured in accordance with the BET method of from 15,000 to 30,000 m²/kg,
the colloidal silica has an average particle diameter of from 5 nm to 60 nm, a specific gravity of from 1 g/cm³ to 1.5 g/cm³, a specific surface area from 20 to 1500 m2/kg,
the colloidal silica comprises amorphous particles in an aqueous dispersion and the amorphous silica particles carry a negative or neutral surface charge and the dispersion contains from 20% to 55% solids by weight,
the core slurry, face skim coat slurry, and/or back skim coat slurry contain a sag resistance additive comprising at least one of the following: sodium trimetaphosphate, boric acid and/or salts of boric acid, tartaric acid, and/or salts of tartaric acid,
the core slurry, face skim coat slurry, and/or back skim coat slurry contain a strength-enhancing starch comprising a hydroxyethylated or hydroxypropylated starch, a pregelatinized starch, or an uncooked, non-migrating starch, and
the core slurry has a water to stucco ratio of from 0.4 to 1.1.

20. The gypsum board of claim 14, wherein the board has at least one of the following:
(i) a High Temperature Shrinkage (S) of 10% or less in the z direction when heated to 1560° F. (850° C.) according to ASTM C1795-15,
(ii) a Thermal Insulation Index (TI) of 20 minutes or greater according to ASTM C1795-15,
(iii) a High Temperature Thickness Expansion in the z direction of at least 0.1% when thickness is evaluated according to the analogous techniques and methodology of ASTM C1795-15, and/or
(iv) where, when the board is cast at a nominal thickness of ⅝-inch, an assembly is constructed in accordance with any one of UL Design Numbers U305, U419 or U423, the assembly having a first side with a single layer of gypsum boards and a second side with a single layer of gypsum boards, and surfaces of gypsum boards on the first side of the assembly are heated in accordance with the time-temperature curve of ASTM E119-09a, while surfaces of gypsum boards on the second side of the assembly are provided with temperature sensors pursuant to ASTM E119-09a, the gypsum boards inhibit the transmission of heat through the assembly such that: a maximum single value of the temperature sensors is less than 325° F. plus ambient temperature after at least 60 minutes; or an average value of the temperature sensors is less than 250° F. plus ambient temperature after at least 60 minutes.
